(19) United States
(12) Patent Application Publication
(10) Pub. No.: US 2009/0271332 A1
(43) Pub. Date: Oct. 29, 2009

(54) COMPUTER SYSTEM AND METHOD FOR GENERATING AND MAINTAINING A FINANCIAL BENCHMARK

(76) Inventors: Andrew W. LO, Cambridge, MA (US); Pankaj N. PATEL, New York, NY (US)

Correspondence Address: MORRISON & FOERSTER LLP, 1650 TYSONS BOULEVARD, SUITE 400, MCLEAN, VA, 22102, US

(21) Appl. No.: 12/325,978

(22) Filed: Dec. 1, 2008

Related U.S. Application Data
(60) Provisional application No. 60/991,530, filed on Nov. 30, 2007.

(51) Int. Cl. G06Q 40/00

(52) U.S. Cl. 705/36 R; 705/37

(57) ABSTRACT

A method for generating and maintaining a benchmark using a long/short investment strategy is disclosed herein. The method for generating and maintaining a benchmark using a long/short investment strategy may involve generating a benchmark by selecting a group of securities from a broad-base index; evaluating the securities included in a benchmark; and monthly rebalancing the benchmark using a long/short investment strategy. The method may also include determining the value of the index and publishing the value of the index as a benchmark for long/short investment portfolios. The value of the index may be determined periodically, daily, dynamically, or every 15 seconds. The securities included in the broad-base index may form a universe of eligible securities and be ranked monthly using the 10 Credit Suisse factors. Also disclosed herein are a method for generating and managing a passive long/short investment portfolio that closely correlates with a passive long/short benchmark, and a method of using a passive long/short benchmark to rebalance a portfolio. Also, a computer system for generating or maintaining a passive long/short benchmark, a computer program for generating or maintaining a passive long/short benchmark, a computer-readable medium storing a program configured to generate or maintain a passive long/short benchmark, and methods of using the same are disclosed herein.

### CROSS-REFERENCE TO RELATED APPLICATION

This application claims the benefit of U.S. Provisional Application No. 60/991,530, filed on Nov. 30, 2007, the entire contents of which are incorporated herein by reference.

### FIELD OF THE INVENTION

The present invention relates to a financial benchmark. More particularly, the present invention relates to a computer implemented financial benchmark, and products based on a long/short investment strategy.

### BACKGROUND OF THE INVENTION

In the financial sector, various stock market indexes are used to determine investor sentiment and to assess the performance of various sectors of the market, such as stocks of individual companies, mutual funds, professionally managed portfolios, etc. Some stock market indexes, such as broad-base indexes, are used to assess the performance of the entire stock market, for example, to determine the overall state of the economy. These broad-base indexes are commonly used as benchmarks in assessing the performance of professionally managed investment portfolios, mutual funds, etc.

Some of the most commonly quoted broad-base indexes are the S&P 500 Index, the American Dow Jones Industrial Average, the Russell 2000 Index, the British FTSE 100, the French CAC 40, and the Hong Kong Hang Seng Index, among others. These indexes each utilize different criteria to assess the performance of the relevant stock market. For example, the Dow Jones Average is a price-weighted index in which only the price of each component stock is considered to determine the value of the index, while the Hang Seng Index is a market-value weighted index that factors in the size of a company as well as the stock price of that company.

The S&P 500 Index refers to a value weighted broad-base index that tracks the performance of stocks from 500 companies chosen by Standard and Poor's according to various criteria. Standard and Poor's also maintain other broad-base indexes, including the S&P 1500 Index and the S&P Global 1200 Index.

A financial portfolio refers to a collection of investments, including stocks, bonds, options, futures contracts, real estates, mutual funds, shares in other portfolios, or other items expected to retain their value over time. Financial portfolios may often be maintained or managed by individual investors, financial institutions, or professional investment managers. To limit losses and to maximize returns, some financial institutions conduct their own investment analysis.

There are several methods of assessing the return of a financial portfolio. A traditional method is based only on the price of the securities in the portfolio. However, such a traditional method is often not an accurate assessment of the true performance of the portfolio. The price of the investment assets in the portfolio may fluctuate over time, based on the sentiment of other investors or the health of the economy as a whole.

Another method for assessing the return may be to compare the performance of a portfolio to a benchmark. The S&P 500 Index, for example, is a commonly used benchmark to assess the return of various portfolios. For example, if a professionally managed portfolio returns 3% over a certain period, and the S&P 500 Index returns 1%, the professionally managed portfolio out-performed the benchmark by an active return of 2%.

One of the fastest growing areas in institutional investment management is the so-called long/short strategy, such as the “130/30” class of strategies, in which the short-sales constraint of traditional long-only portfolio is relaxed. Fueled both by the historical success of long/short equity hedge funds and the increasing frustration of portfolio managers at the apparent impact of long-only constraints on performance, 130/30 products have grown to over $75 billion in assets by 2007 and could reach $2 trillion by 2010.

Despite the increasing popularity of such strategies, there is still considerable confusion among managers and investors regarding the appropriate risks and expected returns of 130/30 products. For example, by construction, the typical 130/30 portfolio has a leverage ratio of 1.6-to-1, unlike a long-only portfolio that makes no use of leverage. Leverage is usually associated with higher-volatility returns; however, the typical 130/30 portfolio's volatility is comparable to that of its long-only counterpart, and its market beta is approximately the same. Nevertheless, the added leverage of a 130/30 product suggests that the expected return should be higher than its long-only counterpart. However, it is difficult to assess by how much the expected return is higher. By definition, a 130/30 portfolio holds 130% of its capital in long positions and 30% in short positions. Therefore, it may be viewed as a long-only portfolio plus a market-neutral portfolio with long and short exposures that are 30% of the long-only portfolio's market value. However, the active portion of a 130/30 strategy is typically very different from a market-neutral portfolio. Hence this decomposition is, in fact, inappropriate.

These unique characteristics suggest that existing indexes such as the S&P 500 Index and the Russell 1000 are inappropriate benchmarks for leveraged dynamic portfolios such as 130/30 funds.

### SUMMARY OF THE INVENTION

The present invention relates to a benchmark and method of providing a benchmark for a long/short investment portfolio that incorporates the same leverage constraints and portfolio construction algorithms as 130/30 funds, but is otherwise transparent, investable and passive. The present invention also relates to a computer implemented system for generating and maintaining a benchmark for a long/short investment portfolio, a computer implemented system for maintaining a portfolio that correlates closely to such a benchmark, and methods of using the foregoing. The present invention also relates to a method for recommending or executing computer-assisted financial instrument transactions that involves running a query against such a benchmark, and a method for generating and managing a passive long/short investment portfolio that closely correlates with a passive long/short benchmark.

The benchmark may be a passive but dynamic benchmark including a standard 130/30 strategy using well-known and/or publicly available factors to rank stocks and standard methods for constructing 103/30 portfolios based on these rankings. Based on this strategy, two types of indexes may be produced: an investable index and a “look-ahead” index, in which the former uses only prior information and the latter uses realized returns to produce an upper bound on performance. One 130/30 strategy may involve rebalancing the constituent stocks of the benchmark on a periodic basis, producing over time a benchmark time-series of returns. The constituent stocks may be rebalanced according to any periodic basis, including weekly, monthly, quarterly, semi-annually, etc. Because only information available prior to each rebalancing date is used to formulate the portfolio weights, the index is a truly investable index. The data and the algorithm for determining the constituent stocks of the benchmark may be provided to the investors. Thus, the index may be passive and transparent as well as investable.

The method for generating and maintaining a benchmark using a long/short investment strategy according to an embodiment may involve: generating a benchmark portfolio by selecting a group of securities from an eligible universe of liquid securities, for example, the securities included in a broad-base index or the top 500 U.S. securities based on market capitalization; periodically evaluating the securities in the benchmark portfolio; and monthly rebalancing the benchmark portfolio using a long/short investment strategy. The method may also involve determining the value of the benchmark portfolio and publishing the value of the benchmark portfolio as a benchmark for a long/short investment portfolio. The value of the benchmark portfolio may be determined periodically, for example, quarterly, monthly, daily, hourly, every minute, every 15 seconds or less, or dynamically. Likewise, the value of the benchmark portfolio may be published as a benchmark periodically, for example, quarterly, monthly, daily, hourly, every minute, every 15 seconds or less, or dynamically. Also, the securities to be included in the benchmark portfolio may be determined, for example, using, at least in part, well-known and/or widely available quantitative and/or qualitative alpha forecast factors such as, for example, the 10 Credit Suisse alpha factors.

The method for generating and managing a passive long/short investment portfolio that correlates with a benchmark according to an embodiment may involve: creating a portfolio of securities based on a benchmark that uses a long/short investment strategy; monthly evaluating the securities of the portfolio; monthly rebalancing the portfolio to correlate with the benchmark; and offering a portion of the security to an investor, in which the evaluating involves using expected return estimating factors involving each of the securities' traditional value; relative value; historical growth; expected growth; profit trend; accelerating sales; earnings momentum; price momentum; price reversal; and small size.

The method of using a long/short benchmark to rebalance a portfolio according to an embodiment may involve: comparing performance of a portfolio to a long/short benchmark; and rebalancing the portfolio using the benchmark, the benchmark being generated and maintained by: monthly evaluating securities in the benchmark portfolio; monthly rebalancing the benchmark portfolio using a long/short investment strategy; daily determining value of the securities in the benchmark portfolio; and publishing the value as a benchmark.

A computer system for maintaining a benchmark according to an embodiment may include: a data storage; an expected return forecasting unit that predicts performance of one or more securities in a benchmark portfolio; and a long/short investment strategy rebalancing unit configured to rebalance the benchmark portfolio using an input from the expected return forecasting unit, in which the rebalancing unit is configured to rebalance the benchmark monthly. Further, the system may include a database configured to store information regarding the securities included in the benchmark.

A computer-readable medium storing instructions executable by a processor according to an embodiment may include instructions for: creating a portfolio of securities using a long/short investment strategy; monthly evaluating the securities of the portfolio; monthly rebalancing the portfolio using a long/short investment strategy; and offering a portion of the security to an investor. The evaluating instruction may involve using expected return estimating factors involving each of the securities' traditional value; relative value; historical growth; expected growth; profit trend; accelerating sales; earnings momentum; price momentum; price reversal; and small size.

A passive long/short financial product according to an embodiment of the present invention may include a portfolio of securities. The contents of the portfolio may be selected by a computer application based on alpha forecast factors, and the contents may be periodically rebalanced on the computer application based on a passive long/short benchmark that uses alpha forecasting factors to rank the securities of the portfolio.

The present invention also includes a financial product, which may include a portfolio of securities, in which the contents of the portfolio is selected based on a query run on a computer application that generates or obtains a passive long/short strategy benchmark. It may also include a computer device that is configured to generate a benchmark based on a long/short strategy and transform the benchmark into a portfolio of securities.

### BRIEF DESCRIPTION OF THE DRAWINGS

The accompanying drawings, which are incorporated herein and form a part of the specification, illustrate the present invention and, together with the description, further serve to explain the principles of the invention by describing a number of embodiments of the present invention.

FIG. 1A is a schematic diagram of a computer network including a device for maintaining a benchmark according to an embodiment of the present invention.

FIG. 1B is a schematic diagram of a computer network including a device for maintaining a benchmark according to an embodiment of the present invention.

FIG. 1C is a schematic diagram of a computer network including a device that maintains an underlying portfolio for a benchmark according to an embodiment of the present invention.

FIG. 2 is a flow diagram depicting a method of generating and maintaining a benchmark according to an embodiment of the invention.

FIG. 3 is a flow diagram depicting a method of generating and maintaining a benchmark according to an embodiment of the invention.

FIG. 4 is a flow diagram depicting a method of maintaining a benchmark according to an embodiment of the invention.

FIG. 5 is a schematic diagram depicting units of a computer system that maintains a benchmark according to an embodiment of the invention.

FIG. 6A is a schematic diagram depicting units of a computer system that maintains a benchmark according to an embodiment of the invention.

FIG. 6B is a schematic diagram depicting units of a computer system that maintains a benchmark according to an embodiment of the invention.

FIG. 7 is a graph depicting the cumulative returns of a passive 130/30 Investable Index according to an embodiment of the invention to that of other broad-base indexes.

FIG. 8 is a table summarizing statistics for monthly returns of 130/30 Investable and Look-Ahead Indexes according to an embodiment of the invention.

FIG. 9 is a table summarizing the annual geometrically compounded returns of a CS 130/30 Investable Index accordingly to an embodiment of the invention.

FIG. 10 is a table summarizing the monthly returns of a passive 130/30 Investable Index according to an embodiment of the invention.

FIG. 11 is a table summarizing the correlations of 130/30 Investable and Look-Ahead Indexes to various market and hedge-fund indexes according to an embodiment of the invention.

FIG. 12 is a table summarizing the monthly turnover and annualized tracking error for a passive 130/30 Investable Index according to an embodiment of the invention.

FIG. 13 is a table summarizing a monthly turnover and annualized tracking error for a passive 130/30 Investable Index according to an embodiment of the invention.

FIG. 14 is a table summarizing the turnover rate of various S&P indexes.

FIG. 15 is a table summarizing the number of securities held long and short each month in a passive 130/30 Investable Index according to an embodiment of the invention.

### DETAILED DESCRIPTION OF THE INVENTION

Specific embodiments of the present invention are now described with reference to various figures. While specific embodiments are described, it should be understood that this is done for illustrative purposes only. A person skilled in the art will recognize that other configurations may be used without departing from the spirit and scope of the present invention.

Utilizing an algorithm or dynamic portfolio as an index is a significant departure from the norm. Existing indexes, such as the S&P 500 Index, are baskets of securities that change only occasionally—not dynamic trading strategies requiring monthly rebalancing. Indeed, the very idea of monthly rebalancing is at odds with the passive buy-and-hold ethos of indexation. The dynamic strategy of the present invention may be considered passive because the rebalancing algorithm is sufficiently mechanical and easily implementable.

Some embodiments may be directed to a passive benchmark for long/short financial products that utilizes a 130/30 investment strategy to determine the constituents of the benchmark—not a static or “buy-and-hold” basket of securities like the S&P 500 Index. Such an index may have at least two distinct functions: (1) a passive benchmark against which active managers may compare the performance of their portfolios, and (2) a transparent, investable and passive portfolio that has a risk/reward profile which appeals to a broad range of investors.

A key concept in these two functions is the term “passive,” which most investors and managers equate with low-cost static buy-and-hold portfolios. However, a functional definition of passive may be more general: an investment process is called “passive” if it does not require any discretionary human intervention. Thus, a benchmark that does not require discretionary inputs of a human being to choose which securities should be included in the benchmark during the rebalancing may be referred to as a passive benchmark. In the 1970s, this notion of passive investing would have implied a static value-weighted portfolio. But with the many technological innovations that have transformed the financial landscape over the last three decades—for example, automated trading platforms, electronic communications networks, computerized back-office and accounting systems, and straight-through processing—the meaning of passive investing has changed.

Some embodiments are directed to a passive index that involves a mechanical investment process that leads to a standard 130/30 portfolio. There may be two basic components to a 130/30 strategy: forecasts of expected returns or “alphas” for each stock in the portfolio universe, and an estimate of the covariance matrix used to construct an efficient portfolio. Some embodiments may use a set of 10 composite alpha factors covering a broad range of valuation models ranging from investment style to technical indicators. A simple equal-weighted average of these 10 factors may be used as a generic expected-return forecast. Also, a covariance matrix may be used to construct a mean-variance efficient portfolio. Further, an upper bound on the performance of a 130/30 portfolio may be calculated as a “look-ahead” index by using the realized monthly returns of each security instead of a forecast in the portfolio optimization process. This upper bound may serve as a yardstick for measuring the economic significance of the alpha being captured by a particular portfolio.

In the context of the present invention, a security refers to any asset or liability, including, but not limited to, stocks, bonds, options, futures contracts, real estate, mutual funds, shares in other funds, or other items expected to retain their value. Further, the terms “stock” and “security” are used interchangeably.

A computer in the context of the present invention refers to various devices having the ability to process data, including, but not limited to, personal computers, laptops, PDAs, and the like. Likewise, a data storage device includes the cache of a computer device, external or internal hard-drives, floppy disks, CD-Rom, and other recordable medium.

A portfolio manager, in the context of this invention, refers to any person, institution, software, or computer-implemented system that manages the content of a portfolio by determining which securities to include.

Alpha forecast factors, in the context of this invention, refers to any factors that may be used to predict or to forecast the expected returns of a security, including but not limited to value-weighted and non-traditional value weighted information. The 10 Credit Suisse factors discussed below are an example of alpha forecast factors.

A 130/30 investment strategy, in the context of this invention, refers to an investment strategy that uses financial leverage by shorting poor performing securities and purchasing shares that are expected to have high returns. In a 130/30 portfolio, securities up to 30% of the portfolio value may be shorted, the proceeds of which can be used to take a long position in securities that a portfolio manager thinks might outperform the market, for example. For example, a portfolio manager may rank the securities in an eligible universe based on expected returns, short sell the bottom ranking securities in the portfolio, up to 30% of the portfolio's value, and reinvest the cash earned in top-ranking securities.

Some embodiments of the present invention concern a benchmark for a long/short investment portfolio. A long/short investment portfolio includes 130/30 investment portfolios, 150/50 investment portfolios, and other investment portfolios commonly referred to as the 1X0/X0 investment portfolios. These portfolios are managed by holding a predetermined portion of the portfolio in long positions and holding some portion of the portfolio in short positions. For example, by definition, a 130/30 portfolio holds 130% of its capital in long positions and 30% in short positions.

A benchmark for such a long/short investment portfolio, according to certain embodiments of the present invention, also incorporates the same leverage constraints as the long/short portfolio to be assessed. Further, the benchmark is transparent, investable, and passive. In other words, the benchmark is constructed using a systematic and clear set of rules; the components of the portfolio of the benchmark consist of liquid exchange-traded instruments; and the implementation of the index is purely mechanical, requiring little or no manual intervention or discretion.

According to certain embodiments of the present invention, various quantitative and qualitative factors may be used to evaluate constituent securities among a selected universe of securities in order to generate a benchmark according to the invention. As a non-limiting example, 10 Credit Suisse factors may be used to generate a benchmark for a passive 130/30 investment portfolio. The 10 Credit Suisse factors are commercially available valuation factors from the Credit Suisse's Quantitative Equity Research Group. The 10 Credit Suisse factors relate to: (1) traditional value; (2) relative value; (3) historical growth; (4) expected growth; (5) profit trend; (6) accelerating sales; (7) earnings momentum; (8) price momentum; (9) price reversal; and (10) small size of each security. These factors cover a broad range of valuation models ranging from investment style to technical indicators. The Credit Suisse factors are periodically updated.

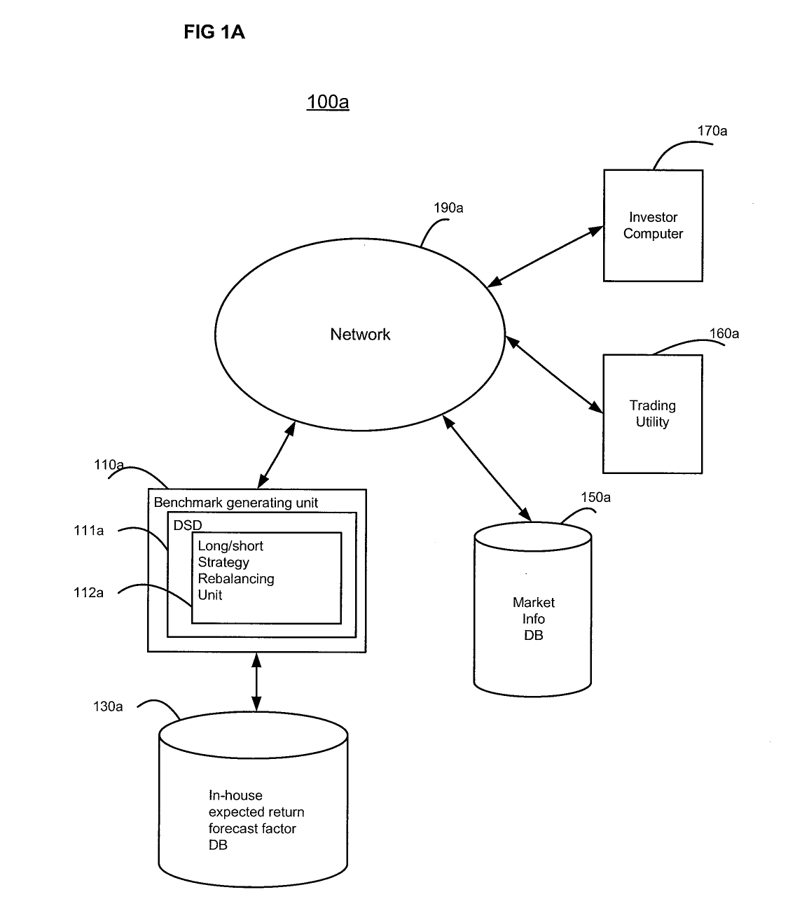

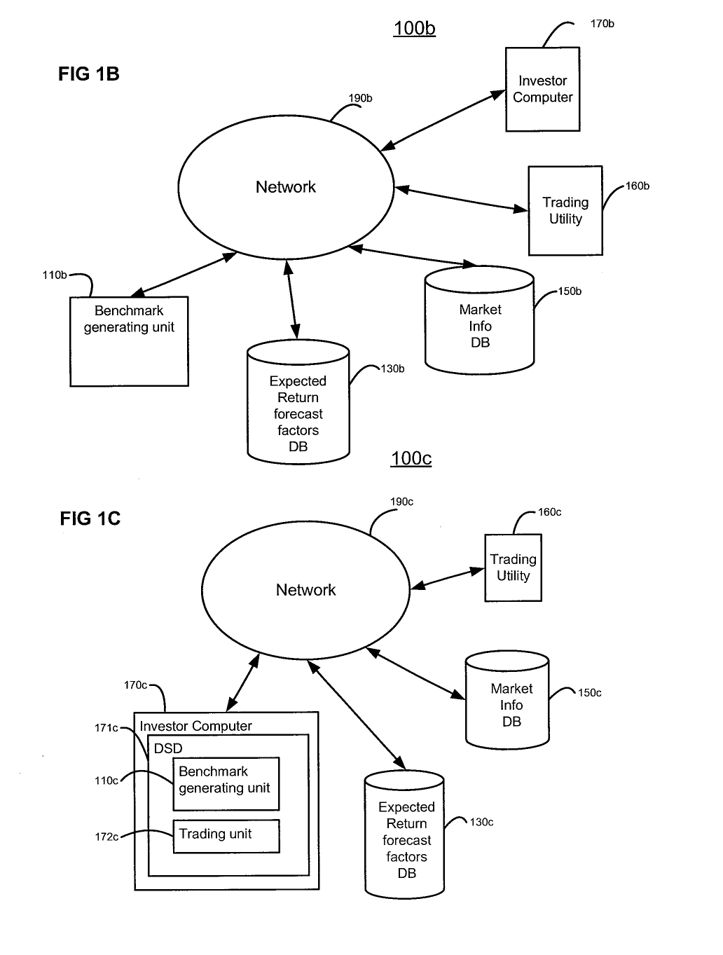

FIG. 1A is a computer network system 100a that may be used to practice one embodiment of the present invention. It is to be understood that each of the database, computer programs, etc. depicted may be housed in one or more computers or computer processing devices, or even can be dispersed over one or more networks.

The computer network system 100a may include a benchmark generating unit 110a. The benchmark generating unit 110a may use information regarding the expected returns of a group of securities to determine which securities should be to include in the underlying portfolio of the benchmark. The benchmark generating unit 110a may be connected to an in-house database 130a that contains information regarding attributes of a group of securities that may be useful to forecast the future performance of the securities. An example of such information is the Credit Suisse factors. The database 130a may be a static database, a periodically updated database, or a dynamically updated database.

The benchmark generating unit 110a may be implemented on a personal computer or other information processing device. In FIG. 1a, the benchmark generating unit 110a is implemented on a computer as software stored on a data storage device (DSD) 111a. The benchmark generating unit 110a may also connected to one or more third-party databases over a network. For example, in FIG. 1a, the benchmark generating unit 110a connects to a third-party market information database 150a via a network 190a. The database 150a may include information regarding the constituent securities of a selected universe of securities. The selected universe of securities may be the top 500 U.S. securities, based on market capitalization. According to one non-limiting embodiment of the invention, database 150a may include information regarding the companies that are included in the S&P500 Index or the S&P1500 Index, or a database containing performance information regarding all securities exchanged in certain stock exchange, etc. Further, for some embodiments, it is possible to obtain the market information by a direct manual input into a computer. For example, the user of a benchmark generating unit 110a may manually input certain information via a keyboard.

The computer network system 100a may also include a trading utility 160a, where actual trading of securities may take place. An example of the trading utility 160a includes the New York Stock Exchange, the NASDAQ, etc. To trade on stocks or securities that are not available on a computer accessible platform, a broker may be asked to perform the actual selling and buying of the security. For certain embodiments, the benchmark generating unit 110a may directly access the trading utility 160a via the network 190a.

The computer network system 100a may also include one or more investor computers 170a. For example, an investor may like to receive the latest benchmark from the benchmark generating unit 110a via the network 190a. The latest benchmark may be used to rebalance the portfolio owned by the investor. The investor computer 170a may receive a dynamic or periodic update of the benchmark generated by the benchmark generating unit 110a. In addition, if there is a portfolio or a financial product that closely correlates with the benchmark, an investor may be able to purchase a portion of such a portfolio or financial product.

FIG. 1B illustrates another embodiment of the present invention. The benchmark generating unit 110b depicted in FIG. 1B may obtain information regarding the future performance of a group of securities from an expected return forecast database 130b via a network 190b. For example, a financial institution that manages the expected return forecast database 130b may provide alpha forecast factors to the benchmark generating unit 110b via the Internet. The benchmark generating unit 110b may also obtain market information from yet another database 150b. The benchmark generating unit 110b may use the information to determine which securities should be included in the benchmark portfolio based on a long/short investing strategy as implemented on a long/short portfolio optimizing unit 112b.

The software located on an investor computer 170b may be configured to access the benchmark generated by the benchmark generating unit 110b via the internet 190b and may use the information to assess the performance of the investor's portfolios periodically or dynamically.

In FIG. 1C, the benchmark generating unit 110c is installed on an investor's computer 170c. Such a benchmark generating unit 110c may be configured to generate a benchmark by setting up a virtual benchmark portfolio. The computer 170c may also be configured to actually manage a fund by trading at one or more stock markets. If an actual fund is managed, the investor's computer 170c may include a trading unit 172c along with a benchmark generating unit 110c. The trading unit 172c may be configured to conduct actual financial transactions via a network 190c.

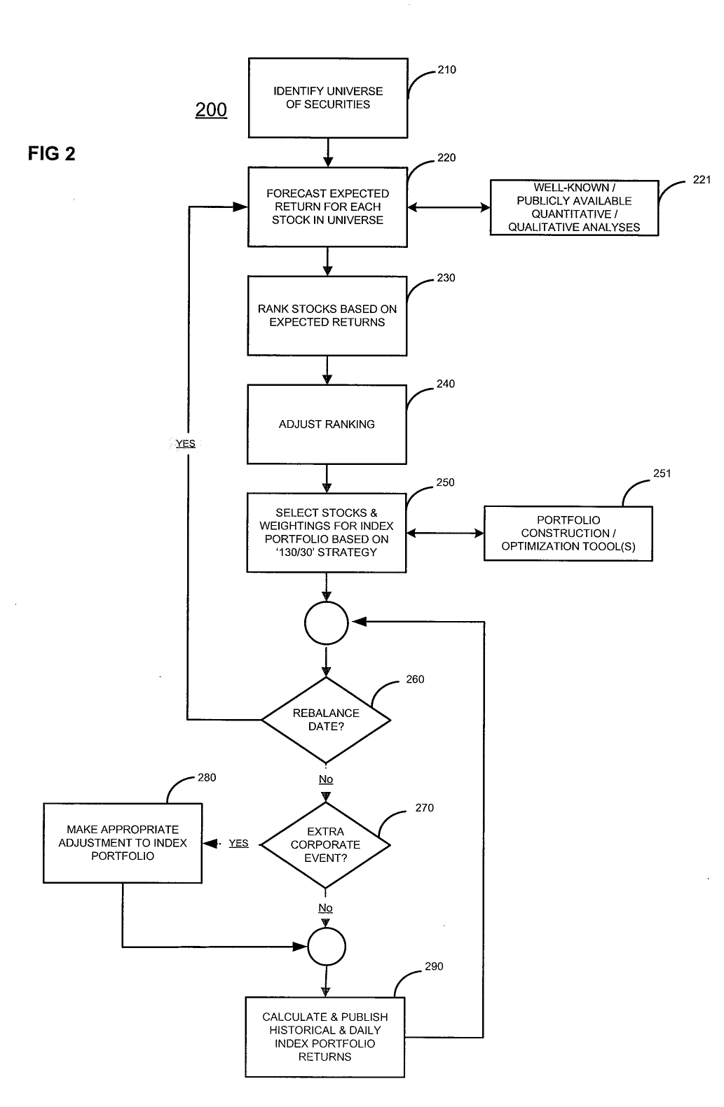

FIG. 2 is a flow diagram depicting a method of generating and maintaining a benchmark according to an embodiment of the invention. In step 210, the universe of securities to be used is identified. A preferred universe of securities is the top 500 U.S. securities, based on market capitalization. Other universes of securities that may be used according to the invention include the securities contained in one or more broad-base indexes, such as the S&P 500 Index or the S&P 1500 Index. In steps 220 and 221, the expected return for each security in the identified universe is forecasted based on well-known and publicly available qualitative and/or quantitative factors. According to one embodiment, the universe of securities can be evaluated according to the Credit Suisse alpha forecast factors. For example, the Credit Suisse factors for all of the securities included in a broad-base index may be obtained. In step 230, the securities in the identified universe can be ranked based on their expected returns as calculated in step 220. In step 240, the rankings of the securities in the selected universe can be adjusted by, for example, excluding stocks having an average trading volume of less than US $10 million per day over a predetermined period (insufficient liquidity) or stocks trading at an average price of less than US$ 5 per share over a predetermined period (under capitalization). For example, securities from small companies or securities with extremely poor performance may be removed from the identified universe of securities, and the rest of the securities may be re-ranked. In step 250, stocks are selected for inclusion in an index portfolio based on a 130/30 investment strategy. The selection of stocks for inclusion into an index portfolio may be accomplished using various portfolio construction and optimization tools as depicted in step 251. With the use of some portfolio construction and optimization tools, building the index portfolio may involve selecting stocks and weights for the stocks and inputting those information into a builder optimizer as depicted in steps 250 and 251. According to one embodiment, the selection and weighting of stocks in the 130/30 index portfolio can be performed using a MSCI Barra Aegis Portfolio Manager provided with a Barra U.S. Equity Long-Term Risk Model. Once the index portfolio is constructed, historical and daily index portfolio returns may be calculated and published as depicted in step 290, either periodically or dynamically.

Also on a periodic basis, the index portfolio is rebalanced to ensure that the index portfolio continues to follow a 130/30 investment strategy with optimal returns. As shown by step 260, rebalancing the index portfolio may involve repeating steps 220 through 250 of FIG. 2., described above. Construction of the rebalanced index portfolio may be unconstrained or it may be constrained according to a percentage annual turnover. According to unconstrained rebalancing, there may be no constraints on the securities that are selected for the construction of the rebalanced index portfolio. According to constrained rebalancing, the movement of securities into and out of the index portfolio may not exceed a pre-selected constraint. For example, if the constraint is set at 15% annually, then the value of rebalancing transactions (securities that are moved into and out of the index portfolio) over the course of one year may not exceed 15% of the total value of the index portfolio. Similarly, if the rebalancing constraint is set at 100%, then the value of rebalancing transactions over the course of one year may not exceed 100% of the total value of the index portfolio.

Further, as shown at steps 270 and 280 of FIG. 2, adjustments may be made to the index portfolio at any time in the event an extraordinary corporate event occurs relating to a security in the current index portfolio. Extraordinary corporate events that might require an adjustment to the index portfolio may include, but are not limited to, stock splits, mergers, acquisitions, bankruptcies, and the like.

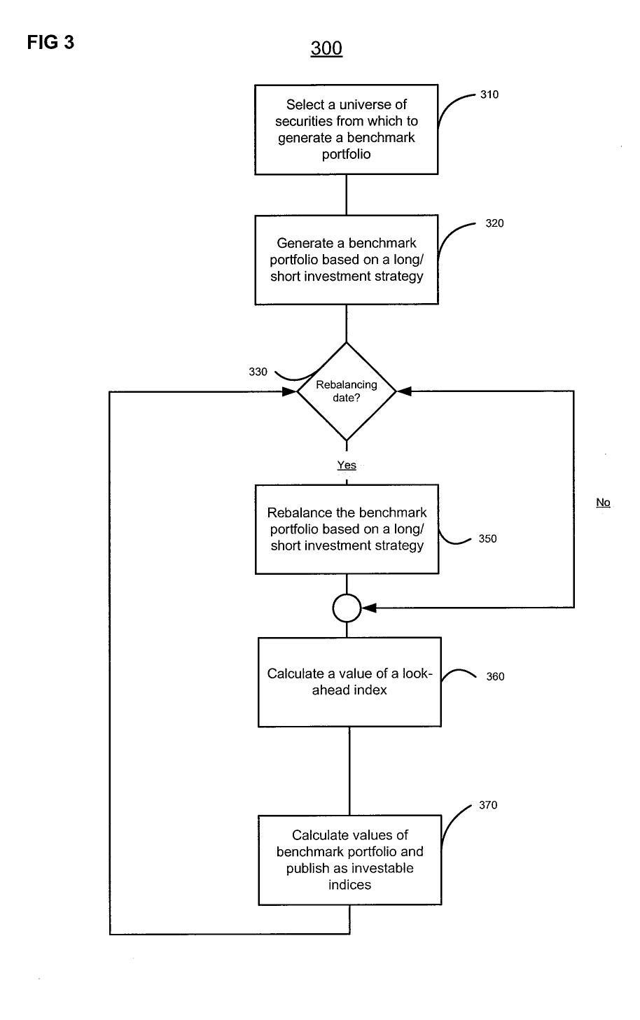

FIG. 3 is a flow diagram depicting a method for generating and maintaining a benchmark according to another embodiment of the invention. The method depicted in this flow diagram may be implemented on a computer to automatically generate and maintain a benchmark for a passive 130/30 investment portfolio.

The method 300 comprises the initial steps of selecting, from a universe of securities, a group of securities from which to generate a benchmark portfolio as in step 310, generating a benchmark portfolio that includes those securities as constituents as in step 320, rebalancing the constituents of the benchmark portfolio based on a long/short investment strategy as in step 350, calculating the value of a look-ahead index as in step 360, calculating the values of the benchmark portfolio, and publishing the values as investible indices as in step 370. In addition, a synthetic price index may also be calculated.

While there are several different types of long/short investment strategies, the 130/30 investment strategy may be used. To render the resulting benchmark an accurate indicator for measuring the performance of 130/30 products, step 350 may apply a 130/30 investment strategy to select the constituents of the benchmark portfolio.

Further, one or more index values may be calculated periodically as shown in steps 360 and 370. For example, the value of all the securities included in the benchmark portfolio may be weighed to calculate the value of the index, which may be published as a benchmark at step 370. In addition, a look-ahead index, which represents an upper bound on the performance of a 130/30 portfolio, may be calculated using the realized monthly returns of each securities as shown in step 360. Such an index may be published with the benchmark, or be used to assess which securities should be included in the next benchmark portfolio. Further, a synthetic price index may be calculated and included.

The benchmark portfolio is rebalanced periodically, as shown in step 350. This period is preferably one month. The rebalancing may occur periodically, i.e., semi-annually, quarterly, monthly, weekly, or biweekly, etc. When a long/short investment strategy is applied to select which securities should be included in the benchmark portfolio, a group of eligible securities may be ranked to determine which and how many shares of the non-constituent securities that are expected to perform well in the future may be included in the benchmark portfolio in place of constituent securities that are expected to perform poorly.

Certain embodiments of the present invention involve a method of generating a passive 130/30 benchmark based on a 130/30 investment strategy. Further, for certain embodiments, the Credit Suisse factors may be used to rank the securities included in the benchmark. Such an embodiment is described in the context of the method 300 as follows.

To create such a benchmark, in step 310, a group of securities to include in the benchmark may be selected from a universe of securities. The universe of securities may be defined according to the user. A preferred universe of securities is the top 500 U.S. securities, based on market capitalization. Other universes of securities that may be used according to the invention include the securities contained in one or more broad-base index, such as the S&P 500 Index or the S&P 1500 Index. In the alternative, the group of securities may be selected from stocks or securities exchanged at certain stock exchange or certain diversified portfolio. These may form a collection of eligible securities that may be included in the benchmark portfolio.

To determine which securities to include in the benchmark portfolio, all securities included in the selected universe of securities may be ranked using various known qualitative and/or quantitative factors. According to one embodiment, the securities in the selected universe may be evaluated and ranked according to the Credit Suisse factors, for example, and a long/short investment strategy may be applied as shown in step 320 to generate the first benchmark portfolio.

On each rebalancing date, the portfolio manager may collect the qualitative and quantitative evaluation factors, sometimes referred to as “alpha forecast factors,” for each of the securities in the eligible universe of securities to determine which securities may be included in the rebalanced benchmark portfolio, as shown in 350. Preferably, the alpha forecast factors are periodically updated so that the most up-to-date information may be used to predict the future performance of each stock. For example, a database containing the Credit Suisse factors may be accessed. These factors may be combined, for example, using a simple equal-weighted average of the 10 factors for each security, to obtain a number that may be used to forecast the expected return of the security. Based on that number, the securities in the universe may be ranked as necessary.

The rebalancing step may be performed on a computer, for example, by a benchmark generating software. The step involves obtaining the forecasts of expected returns or “alphas” for each security in a given universe of eligible securities, and generating an estimate of a covariance matrix to determine which securities in the benchmark portfolio should be removed and replaced with which and with how many shares of non-constituent securities available in the universe of eligible securities. For some embodiments of the invention, the forecasts of expected return may be obtained using the Credit Suisse factors, or other similar factors. The covariance matrix used to construct a mean-variance efficient portfolio may be like the one given by the Barra U.S. Equity Long-Term Risk Model.

Further, in step 360, an upper bound on the performance of a passive 130/30 portfolio may be calculated by constructing a “look-ahead” index, using the realized monthly returns of each security. While it might be impossible to achieve such returns because no one has perfect foresight, nevertheless, this upper bound may serve as a yardstick for measuring the economic significance of the alpha being captured by a particular portfolio. Also, in step 370, a synthetic price index may be calculated.

If the method 300 is implemented on a computer, the program may be set to rebalance the benchmark periodically on a set rebalancing date as depicted in step 330. For example, the benchmark may be rebalanced on the last Friday of each month.

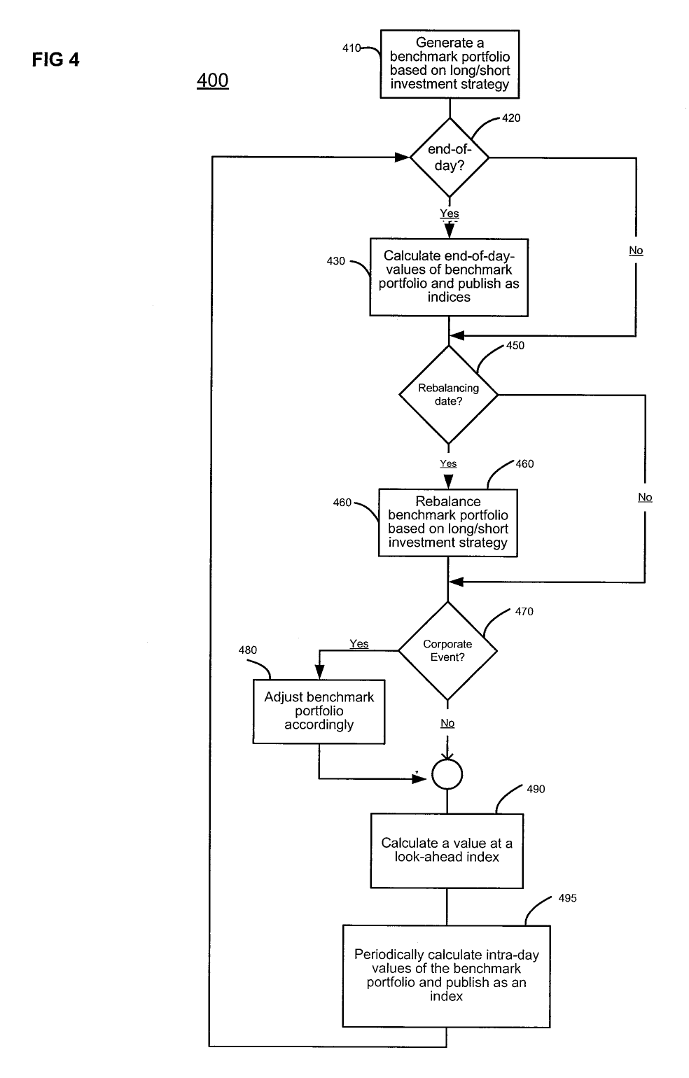

FIG. 4 is a flow diagram depicting a method 400 of maintaining a benchmark portfolio for a passive long/short portfolio according to yet another embodiment of the present invention. The benchmark may be a 130/30 index (hereinafter “130/30 Index”) that an investor may use to assess the performance of their 130/30 portfolios. The value of the constituent securities included in the benchmark portfolio may be assessed, for example, on an end-of-day basis, based on the closing prices of the securities as shown in step 430. The value of the constituent securities may also be published on an end-of-day basis. In addition, the benchmark portfolio may be rebalanced periodically as shown in steps 450 and 460. The period may be one month or a quarter. In addition, over time, there may be certain corporate events or major changes at corporations that require making non-uniform adjustments to the constituents of the benchmark. For example, stock splits, mergers and acquisition, and like, may require a certain security to be removed and replaced with another security. This type of adjustments may occur anytime as necessary as depicted in steps 470 and 480. Further, the value of a look-ahead index may be calculated as necessary as depicted in step 490. This calculation may involve using realized returns of the benchmark portfolio to produce an upper bound on performance of the portfolio. The intra-day values of the benchmark may also be calculated periodically and be published as an index. The period may be as short as one hour, 30 minutes, one minute, or 15 seconds or less.

At step 430, end-of-day value of the 130/30 benchmark portfolio may be calculated based on the closing prices of its constituents in US dollars and published as indices. The Indices may be calculated, for example, in price-return (“the price index”), total-return (“the total return index”) and synthetic price-return (“the synthetic price index”) forms. The Index may have a Base Date of Month on which the index starts, the Date corresponding to the date the benchmark was launched in step 410. The Index may have a starting value of 100 when launched in step 410. The Index may contain long and short stocks.

Further, in some embodiments, an actual passive 130/30 portfolio (“the 130/30 Index Portfolio”) that closely correlates with the Index may be provided as a financial product. Investors may be permitted to purchase a portion of such an index portfolio or financial product, and receive returns that are similar to that of the benchmark. For example, the 130/30 Index may be restricted to include stocks only from companies which are listed on a regulated stock exchange in a single country, such as the Great Britain, France, or the United States. For example, the eligible universe of securities may be set to the top 500 or the top 1500 companies traded in the United States as defined by the market capitalization. The financial product may allow investors to buy shares in the index portfolio. It is, again, possible to generate only a benchmark without setting up an index portfolio of real stocks.

In either case, the constituents of the 130/30 Index may be selected from a defined universe of eligible securities. The companies in the defined universe may then be ranked according to the preferred qualitative and quantitative evaluation factors, for example, the 10 Credit Suisse factors. Those stocks which have an average trading volume of less then US dollars 10 million per day over the last six month period may be excluded. This adjustment may be done to ensure that the performance of the Index is not negatively affected by price disruptions due to a lack of liquidity. When a stock or security has several listings or different share classes outstanding, the Index creator may set a rule as to which stock or security or listing should be considered. Preferably, the primary or most liquid listing may be considered.

The constituent securities may be selected on a monthly basis. For example, it may be carried out on the last weekday of each month to create a selection list. The selection list may indicate possible changes in the composition of the Index at the next rebalance. The selection list may also used to determine a replacement company if and when needed.

The securities included in the Index may be weighted initially and on each monthly rebalancing date. The weighting of each stock may be expressed in the number of shares included in the Index. The number of shares in the Index for each company may be calculated on the Base Date and recalculated on each monthly rebalancing date or after a definite number of days after the rebalancing date.

As depicted in step 430, the value of the Index may be calculated daily and published daily. In addition, it may be periodically updated and published throughout the day. A calculating agent may calculate the value. For the purpose of calculating the end-of-day value, the Index may close at 5 p.m. New York time. The closing Index value may be disseminated by 6.30 p.m. New York time. It may be also possible to perform the calculation dynamically.

The calculating agent, which may be a computer implemented software, may, for example, calculate the value of the index using the following formula:

Price Index Calculation Method

The Index (the price index) is calculated according to the following equations:

$${Index}_{t} = \frac{{\sum }_{i = 1}^{n} {Price}_{it} \times Shares}{{Divisor}_{t}}$$

where:

Indexₜ=Index value at time t

Divisorₜ=Divisor at time t

N=Number of stocks in the Index=60

Priceᵢₜ=The official closing price of stock i at time t in US dollars

Sharesᵢₜ=Number of shares of stock i in the Index at time t

The initial divisor, Divisor₀, is determined as follows:

$${Divisor}_{0} = \frac{{\sum }_{i = 1}^{n} {Price}_{it} \times Shares}{Base Value}$$

where:

Divisor₀=Initial divisor at base date (=xx Month YYYY)

Base Value=100 (=Base Index value on xx Month YYYY)

Price₀=The official closing price of stock i at base date in US dollars

Shares₀=Number of shares of stock i in the Index at base date

Any changes to the Index composition (on the Annual Rebalancing Dates and due to corporate actions) may require adjustments to the divisor in order to maintain Index series continuity. Divisor changes are made according to the following formula:

$${Divisor}_{post adj} = {Divisor}_{pre adj} \times \frac{\sum {Price}_{post adj} \times {Shares}_{post adj}}{\sum {Price}_{pre adj} \times {Shares}_{pre ad}}$$

where:

Divisor_{post adj}=Divisor after changes are made to the Index

Divisor_{pre adj}=Divisor before changes are made to the Index

Price_{post adj}=The official closing price of stock i after Index changes in US dollars

Price_{pre adj}=The official closing price of stock i prior to Index changes in US dollars

Share_{post adj}=Number of shares of stock i in the Index after Index changes

Shares_{pre adj}=Number of shares of stock i in the Index prior to Index changes

When changes to the number of shares are made (e.g. in the case of a constituent replacement), the weight of the constituent should not change. As an example:

$${Shares}_{Stock Out} \times {Price}_{Stock Out}$$

$${Weight}_{stock out} = \frac{{Shares}_{Stock Out} \times {Price}_{Stock Out}}{\sum {Price}_{i}} = {Weight}_{Stock In}$$

$$therefore$$

$${Weight}_{stock in} = \frac{{Shares}_{Stock Out} \times {Price}_{Stock Out}}{\sum {Price}_{stock in}} = {Weight}_{Stock In}$$

The price index might not take normal dividend payments into account. For purposes of calculating the total return index, net dividends may be accounted for by reinvesting them on a daily basis. The ex-dividend date may be used to determine the total daily dividends for each day. Special dividends require an index divisor adjustment to prevent such distributions from distorting the price index. While not illustrated in FIG. 4, some embodiments of the present invention involves checking daily whether any dividend has issued in any of the securities included in the 130/30 Index.

For example, for purposes of calculating the total return index, dividends may be accounted for by reinvesting them on a daily basis (daily compounding) according to the following formulae:

$$Total Return {Index}_{t + 1} = Total Return {Index}_{t} \times \frac{( {Index}_{t + 1} + {Div}_{t + 1} )}{{Index}_{t}}$$

where:

Total Return Indexₜ=Close of the total return index on day t

Indexₜ=Close of the price index on day t as outlined in Appendix 1

DIVₜ=Total net cash dividends (ordinary) for the Index on day t expressed in Index points

Dividendᵢₜ=If it is the ex-dividend date for stock i: the net dividend of stock i in US dollars, else 0.

Sharesᵢₜ and Divisorₜ and are as per Appendix 1.

Net dividend: The dividend may be reinvested after deduction of withholding tax, applying the rate to non-resident individuals who do not benefit from double taxation treaties. The Total Return Index may approximate the minimum possible dividend reinvestment. The rates to be applied are the current effective rates.

The synthetic price index is the total return index adjusted by a synthetic dividend yield, using daily compounding as follows:

$$Synthetic Price Index = Total Return {Index}_{t} \times {( 1 - \frac{SDY}{365.25} )}^{⋀ t}$$

whereby t is measured in calendar days and SDY is the (fixed) synthetic dividend yield: SDY=XX.00%

The index created and maintained by the method 800 of an embodiment of the present invention may be called by the following names:

Price index: Credit Suisse 130/30 US Index

Total return index: Credit Suisse 130/30 US Total Return Index

Synthetic price index: Credit Suisse 130/30 US Index

It is possible that there may be some shorted stocks.

Further, the 130/30 Index may be periodically reviewed to ensure that the underlying constituents continue to meet the basic principles of the 130/30 Index, and that the Index continues to reflect as closely as possible the value of the underlying share portfolio. The periodic review of the Index constituents may be scheduled to occur in accordance with a set timetable.

In the event that a corporate action takes place in respect of an Index constituent during the period between the monthly rebalancing date and the monthly rebalancing effective date which results in Index constituents becoming ineligible, the ineligible constituents may be replaced. The replacement security may, for example, be the highest/lowest ranked non-constituent security on the most recent selection list.

In addition to the periodic reviews, the Index may be continually reviewed for changes to the Index composition necessitated by extraordinary corporate actions, e.g. mergers, takeovers, spin-offs, delistings and bankruptcy filings—involving constituent companies. The aim of the calculation agent when making operational adjustments is to ensure that the basic principles of the Index are maintained and that the Index continues to reflect as closely as possible the value of the underlying portfolio. The replacement company may, for example, be the highest/lowest ranked non-constituent on the most recent selection list.

Further, certain embodiments of the invention relate to a method of generating and maintaining an actual 130/30 fund financial product that closely correlates with the 130/30 Index. The method of maintaining such a fund product may be like that of the method 400 described above, except that actual shares of securities are included in the underlying portfolio.

Various measurements may be used to forecast the expected return of each security. The 10 Credit Suisse factors may be categorized into five broad investment areas: value, growth, profitability, momentum, and technical. Each factor is determined using fundamental data from financial statements, consensus earnings forecasts, and market pricing and/or volume data.

The Credit Suisse's Quantitative Equity Research Group maintains and updates these 10 factors for each of the companies included in the S&P 1500 Index. Thus, for example, each company in the S&P 1500 universe has 10 Credit Suisse factors associated with it for each time period.

The Credit Suisse factors, and the financial indicators that go into their computation, are as follows:

Composite Alpha Factor 1: Traditional Value.

The traditional-value alpha portfolio buys cheap stocks and shorts the expensive ones. The traditional-value factor is constructed using price ratios such as price-to-earnings, price-to-book, price-to-cashflow, and price-to-sales. These types of ratios have long served as the traditional measures of value.

The factors that may be considered in obtaining the traditional value alpha factor are as follows:

Price/12-Month Forward Earnings Consensus Estimate. Here the 12-month forward earnings is calculated as the time-weighted average of FY1 and FY2 (the upcoming and the following fiscal year-end earnings forecasts). The weight for FY1 is the ratio of the number of days left in the year to the total number of days in a year, and the weight for FY2 is one minus the weight for FY1.

Price/Trailing 12-Month Sales. The trailing sales is computed as the sum of the quarterly sales over the last 4 quarters.

Price/Trailing 12-Month Cash Flow. The trailing cash flow is computed as the sum of the quarterly cash flow over the last 4 quarters.

Dividend Yield. This is computed as the total DPS paid over the last year, divided by the current price.

Price/Book Value. For the book value, the last quarterly value is used.

Composite Alpha Factor 2: Relative Value.

The relative-value alpha is determined using value such as industry-relative price ratios as price-to-earnings, price-to-book, and price-to-sales. For example, the industry-relative price-to-earnings ratio of a company XYZ is constructed by taking XYZ's price-to-earnings ratio and standardizing it using the median and standard deviation (computed using the median) of that ratio across all companies in XYZ's industry group. In this approach, a stock is considered cheap if its ratio is less than the industry average.

The factors that may be considered in obtaining the industry-relative value alpha factor are as follows:

Industry-Relative Price/Trailing 12-Month Sales

Industry-Relative Price/Trailing 12-Month Earnings

Industry-Relative Price/Trailing 12-Month Cash Flow

Industry-Relative Price/Trailing 12-Month Sales (Current Spread vs. 5-Year Average)

Industry-Relative Price/Trailing 12-Month Earnings (Current Spread vs. 5-Year Average)

Industry-Relative Price/Trailing 12-Month Cash Flow (Current Spread vs. 5-Year Average)

Composite Alpha Factor 3: Historical Growth.

The historical-growth alpha portfolio buys stocks with a strong record of growth and shorts those with flat or negative growth rates. Growth is measured based on earnings growth rates, revenue trends, and changes in cash flows.

The factors that may be considered in obtaining the historical-growth value alpha factor are as follows:

Number of Consecutive Quarters of Positive Changes in Trailing 12-Month Cash Flow (Counted over the Last 24 Quarters). For each of the last 24 quarters, the trailing 12-month cash flow is computed, and then the number of times the consecutive changes in those trailing cash flows are of the same sign from quarter to quarter, starting with the most recent quarter and going back, are counted. If the consecutive quarter-to-quarter changes are negative, each change is counted as −1. If they are positive, each change is counted as +1.

Number of Consecutive Quarters of Positive Change in Trailing 12-Month Quarterly Earnings (Counted over the Last 24 Quarters). The trailing 12-month quarterly earnings is calculated by summing up the quarterly earnings for the last 4 quarters, and compute the number of consecutive quarters in the same way as in the item above.

12-Month Change in Quarterly Cash Flow. This is the difference between the trailing 12-month cash flow for the most recent quarter and the trailing 12-month cash flow for the quarter one year back from the most recent quarter.

3-Year Average Annual Sales Growth. For each of the last 3 years, the 1-year percentage change in sales is computed, and then the 3-year average of those 1-year percentage changes is computed.

3-Year Average Annual Earnings Growth. For each of the last 3 years, the 1-year percentage change in earnings is computed, and then the 3-year average of those 1-year percentage changes is computed.

12-Quarter Trendline in Trailing 12-Month Earnings. For each of the last 12 quarters, from the trailing 12-month earnings, calculate the slope of the linear trendline fitted to those 12 points, and then divide that slope by the average 12-month trailing earnings across all 12 quarters.

12-Quarter Trendline in Trailing 12-Month Cash Flows. This is calculated in the same way as described in the item above, but using cash flows instead of earnings.

Composite Alpha Factor 4: Expected Growth.

The expected-growth alpha portfolio buys stocks with high rates of expected earnings growth and shorts those with low or negative expected growth rates.

The factors that may be considered in obtaining the expected-growth value alpha factor are as follows:

5-Year Expected Earnings Growth (I/B/E/S Consensus)

Expected Earnings Growth: Fiscal Year 2/Fiscal Year 1 (I/B/E/S)

Composite Alpha Factor 5: Profit Trends.

The profit-trends alpha portfolio buys stocks showing strong bottom-line improvement and shorts stocks showing deteriorating profits or increasing losses. The profit trends maybe measured by using the following ratios: overhead-to-sales, earnings-to-sales, and sales-to-assets. Other trends considered are ratios such as: (receivables+inventories)/sales, and cash-flow-to-sales.

The factors that may be considered in obtaining the profit-trends value alpha factor are as follows:

Number of Consecutive Quarters of Declines in (Receivables+Inventories)/Trailing 12-Month Sales (Counted over the Last 24 Quarters). Start with the most recent quarter, and count back. If the consecutive quarter-to-quarter changes are negative, count each change as +1. If they are positive, count each change as −1. Receivables is calculated as the average of the receivables for this quarter and the quarter one year ago, and the inventories number is calculated similarly.

Number of Consecutive Quarters of Positive Change in Trailing 12-Month Cash Flow/Trailing 12-Month Sales (Counted over the Last 24 Quarters). Start with the most recent quarter, and count back. If the consecutive quarter-to-quarter changes are positive, count each change as +1. If they are negative, count each change as −1.

Consecutive Quarters of Declines in Trailing 12-Month Overhead/Trailing 12-Month Sales (Counted over the Last 24 Quarters). Start with the most recent quarter, and count back. If the consecutive quarter-to-quarter changes are negative, count each change as +1. If they are positive, count each change as −1. The trailing 12-month overhead equals trailing 12-month sales minus trailing 12-month COGS minus trailing 12-month EBEX, where the trailing 12-month values are obtained by summing the quarterly values for the last 4 quarters.

Industry-Relative Trailing 12-Month (Receivables+Inventories)/Trailing 12-Month Sales. Here the industry-relative ratio is obtained by standardizing the underlying ratio using the mean and standard deviation of that ratio across all companies in that industry group.

Industry-Relative Trailing 12-Month Sales/Assets. Here the assets value is the average of the assets for this quarter and the assets for the quarter one year ago. The industry-relative ratio is obtained by standardizing the underlying ratio using the mean and standard deviation of that ratio across all companies in that industry group.

Trailing 12-Month Overhead/Trailing 12-Month Sales. The trailing 12-month overhead equals trailing 12-month sales minus trailing 12-month COGS minus trailing 12-month EBEX, where the trailing 12-month values are obtained by summing the quarterly values for the last 4 quarters.

Trailing 12-Month Earnings/Trailing 12-Month Sales

Composite Alpha Factor 6: Accelerating Sales.

The accelerating-sales alpha portfolio buys stocks with strong records of sales growth and shorts those with flat or negative sales growth. This is determined by measuring the rate of increase in sales growth-hence, the acceleration of sales.

The factors that may be considered in obtaining the accelerating-sales alpha factor are as follows:

3-Month Momentum in Trailing 12-Month Sales. To compute this measurement, first take the difference between the current trailing 12-month sales and the trailing 12-month sales one year ago, and then divide that difference by the absolute value of the trailing 12-month sales one year ago. Afterwards, take the difference between this ratio today and this ratio 3 months ago.

6-Month Momentum in Trailing 12-Month Sales. This is computed in the same way as described above.

Change in Slope of 4-Quarter Trendline through Quarterly Sales. To obtain this number, first calculate the trailing 12-month sales for every quarter for the past 4 quarters, and compute the average of those trailing 12-month sales over the last 4 quarters. Afterwards, compute the slope of the linear trendline through the trailing 12-month quarterly sales, and divide it by the average quarterly sales. Finally, compute the same ratio using the data one year ago, and subtract that value from the current ratio to obtain the change in slope.

Composite Alpha Factor 7: Earnings Momentum.

The earnings momentum is defined in terms of earnings estimates, not historical earnings. The earnings-momentum alpha portfolio buys stocks with positive earnings surprises and upward estimate revisions and shorts those with negative earnings surprises and downward estimate revisions.

The factors that may be considered in obtaining the earnings-momentum alpha factor are as follows:

4-Week Change in 12-Month Forward Earnings Consensus Estimate/Price. The 12-month forward earnings is calculated as the time-weighted average of FY1 and FY2 (the upcoming and the following fiscal year-end earnings forecasts). The weight for FY1 is the ratio of the number of days left in the year to the total number of days in a year, and the weight for FY2 is 1 minus the weight for FY1.

8-Week Change in 12-Month Forward Earnings Consensus Estimate/Price. This is calculated in the same way as described above.

Last Earnings Surprise/Current Price. The last earnings surprise is the difference between the reported and the expected earnings, both of which are reported by I/B/E/S.

Last Earnings Surprise/Standard Deviation of Quarterly Estimates for the Last Quarter (SUE). As reported by I/B/E/S.

Composite Alpha Factor 8: Price Momentum.

The price-momentum alpha portfolio buys stocks with high returns over the past 6-12 months and shorts those with low or negative returns over the past 6-12 months.

The factors that may be considered in obtaining the price-momentum alpha factor are as follows:

Slope of 52-Week Trendline (Calculated with 20-Day Lag)

Percent Above 260-Day Low (Calculated with 20-Day Lag)

4/52-Week Price Oscillator (Calculated with 20-Day Lag). This is computed as the ratio of the average weekly price over the past 4 weeks to the average weekly price over the past 52 weeks, minus 1.

39-Week Return (Calculated with 20-Day Lag)

52-Week Volume Price Trend (Calculated with 20-Day Lag). This is computed in the standard way. Please refer to Colby and Meyers, incorporated herein, (1988, The Encyclopedia of Technical Market Indicators, McGraw-Hill, p. 544).

Composite Alpha Factor 9: Price Reversal.

Price reversal is the pattern whereby short-term winners often suffer downside reversals and short-term losers tend to bounce back to the upside. These reversal patterns are evident for horizons ranging from one day to four weeks.

The factors that may be considered in obtaining the price-reversal alpha factor are as follows:

5-Day Industry-Relative Return. This is calculated as the 5-day return minus the cap-weighted average 5-day return within that industry.

5-Day Money Flow/Volume. To obtain the numerator of this ratio, for each of the past 5 days, compute the closing price times the volume (shares traded) for that day, multiply that by −1 if that day's return is negative, and sum those daily values. To obtain the denominator, simply sum the closing price times the daily volume across the past 5 days (without multiplying those daily products further by −1 if the corresponding daily return is negative).

12-26 Day MACD [S.O.F.T.]-10-Day Signal Line. The MACD and the Signal Line are computed in the standard way as described in Colby, R. and T. Meyers, 1988, The Encyclopedia of Technical Market Indicators, McGraw-Hill, page 281, incorporated herein by reference.

14-Day RSI (Relative Strength Index). This is computed in the standard way as described in Colby, R. and T. Meyers, 1988, The Encyclopedia of Technical Market Indicators, McGraw-Hill, page 433, incorporated herein by reference.

20-Day Lane's Stochastic Indicator, computed as described in Colby, R. and T. Meyers, 1988, The Encyclopedia of Technical Market Indicators, McGraw-Hill, page 473, incorporated herein by reference.

4-Week Industry-Relative Return. This is calculated as the 4-week return minus the cap-weighted average 4-week return within that industry.

Composite Alpha Factor 10: Small Size.

The small-size alpha portfolio buys the smallest decile stocks in the index and shorts the largest decile in the index. The following metrics are used to measure the size: market capitalization, assets, sales, and stock price.

The factors that may be considered in obtaining the small size alpha factor are as follows:

Log of Market Capitalization

Log of Market Capitalization Cubed

Log of Stock Price

Log of Total Last Quarter Assets

Log of Trailing 12-Month Sales

Stocks with high exposure to the 10 alpha factors are forecast to provide positive alpha; stocks with low exposure should generate negative alpha. To make the high number to indicate positive alpha, all the traditional-value and relative-value ratios, with the exception of the dividend yield, may be inverted. For the same reason, all of the price-reversal and small-size individual alpha measurements, as well as the following two profit-trends individual alpha measurements—Industry-Relative Trailing 12-Month (Receivables+Inventories)/Trailing 12-Month Sales and Trailing 12-Month Overhead/Trailing 12-Month Sales—are multiplied by −1.

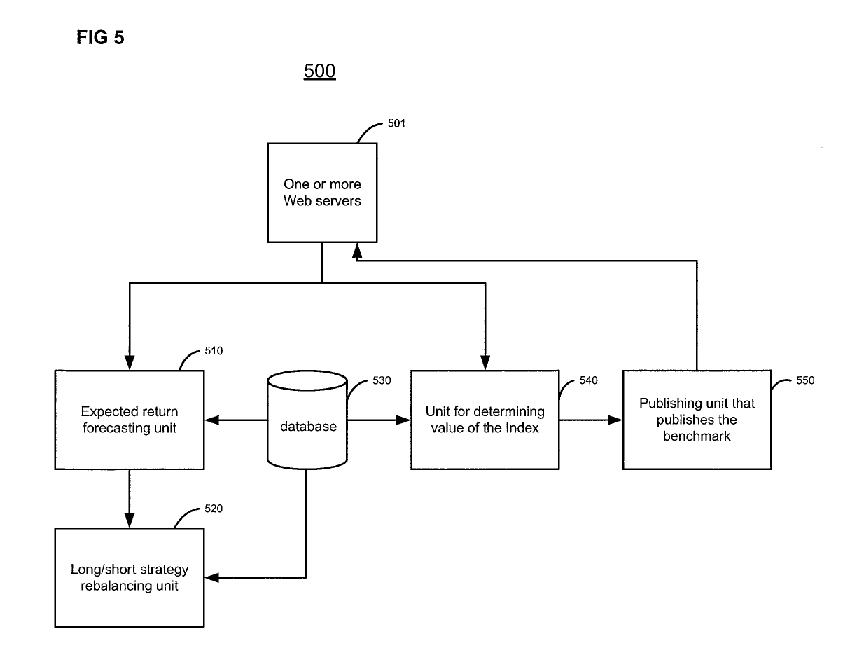

FIG. 5 depicts various processing units of a benchmark generating application 500 that may be installed on a computer. The computer may be connected to a network via one or more web servers 501 to communicate with other databases. For example, the benchmarking generating application 500 may need to obtain alpha forecasting factors via the Internet to rank securities included in the benchmark portfolio. In addition, the benchmark generating application 500 may need to obtain an up-to-date list of a set of eligible companies that may be included in the benchmark portfolio.

The benchmark generating application 500 may also include an expected return forecasting unit 510 that calculates the excess return values of each security in the benchmark and other non-constituent securities in the eligible universe of securities. The excess return values calculated by the expected return forecasting unit 510 may then be used in the long/short investment strategy rebalancing unit 520 to rebalance the benchmark portfolio periodically. For example, the expected return forecasting unit 510 may obtain the Credit Suisse factors relating to each company included in the selected universe of securities to predict the future performance of these securities.

The rebalancing unit 520 may rank securities included in the selected universe based on an input from the expected return forecasting unit 510. The identity of the securities and the number of shares included in the current benchmark portfolio may be obtained from the database 530. The database 630 may also store information regarding the historical performance of the securities that are or were included in the benchmark portfolio.

The benchmark generating application 500 may also include a unit for periodically or dynamically determining the value of the index 540. Such a unit may be connected to the Internet to obtain the value of each constituent securities included in the benchmark portfolio. For example, the value of each securities included in the benchmark portfolio may be obtained on an end-of-day basis to determine the overall value of the index as of that day. The value of the index may be published daily or dynamically by a publishing unit 550 as a benchmark.

It is to be understood that one or more units of the benchmark generating application may be located on separate computers, or even be distributed over one or more networks. Further, those skilled in the art may be able to vary the structure of the units to accomplish the same end. These modifications are parts of the present invention.

In certain embodiments of the present invention, the benchmark generating application 500 may be configured to use alpha forecasting factors similar to the Credit Suisse factors. For example, alpha factors relating to value, growth, profitability, momentum, and technical factors may be used. More specifically, a benchmark generating application 500 may use one or more alpha forecasting factors relating to the securities': (1) traditional value; (2) relative value; (3) historical growth; (4) expected growth; (5) profit trend; (6) accelerating sales; (7) earnings momentum; (8) price momentum; (9) price reversal; and (10) small size, or the like.

Furthermore, each of the alpha forecasting factors may be obtained by normalizing various alpha measurements underlying those factors and obtaining a z-score of those measurements. For example, the traditional-value alpha factor may be determined based on the following five constituent factors: price/book value, dividend yield, price/trailing cash flow, price/trailing sales, and price/forward earnings.

These alpha measurements may be converted into a traditional-value alpha factor by obtaining the price/book value ratio for a particular company on a particular date and normalizing the data based on two-step normalization procedure to compute its z-score based on a sample of all the companies in the selected universe of securities. The price/book value ratio's z-score may be computed by normalizing that ratio using the ratio's cap-weighted mean and its standard deviation across selected universe of securities. This standard deviation may be computed using the cap-weighted mean. The companies with z-scores computed that are greater than 10 in absolute value are dropped from the sample, and the cap-weighted mean and the standard deviation may be re-computed based on this smaller sample. Then, each company's price/book value ratio may be re-normalized for the companies from the original sample. The z-score of dividend yield, price/trailing cash flow, price/trailing sales, and price/forward earnings may be calculated in the same way. To obtain the traditional value alpha-factor z-score, an equal-weighted average of the z-scores of its five constituents is obtained and then normalized in two steps as described above.

The alpha factor for each of the other nine categories may be obtained in the same way given its corresponding constituent indicators. Then, for each company in the universe, and for each date, the equal-weighted average of its 10 alpha factors may be used as an excess-return input that is fed to a long/short investment strategy rebalancing unit 520.

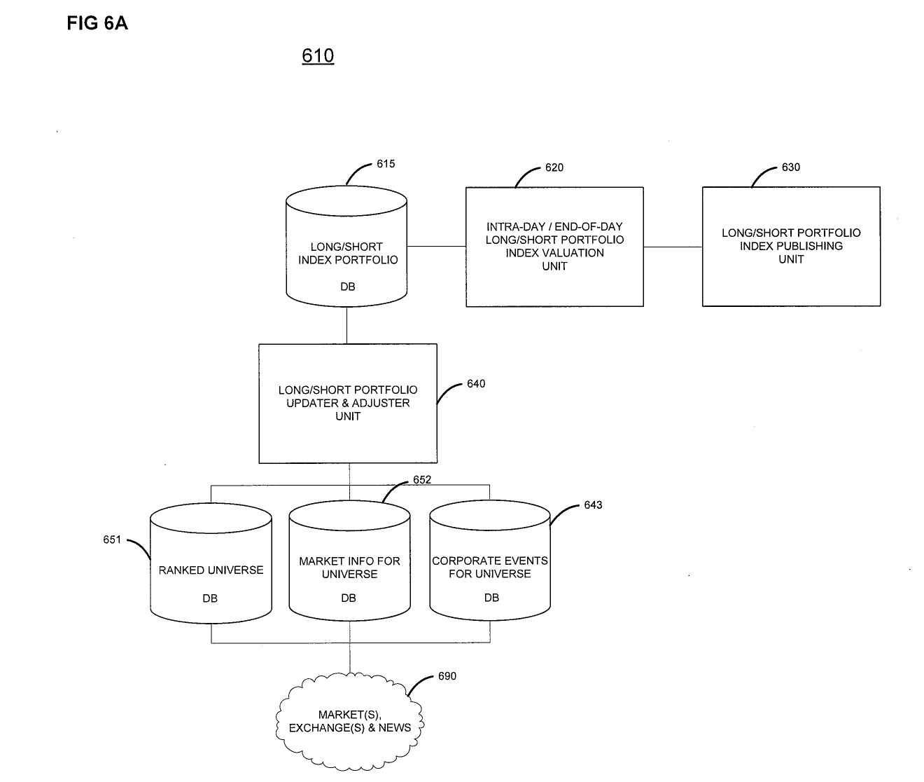

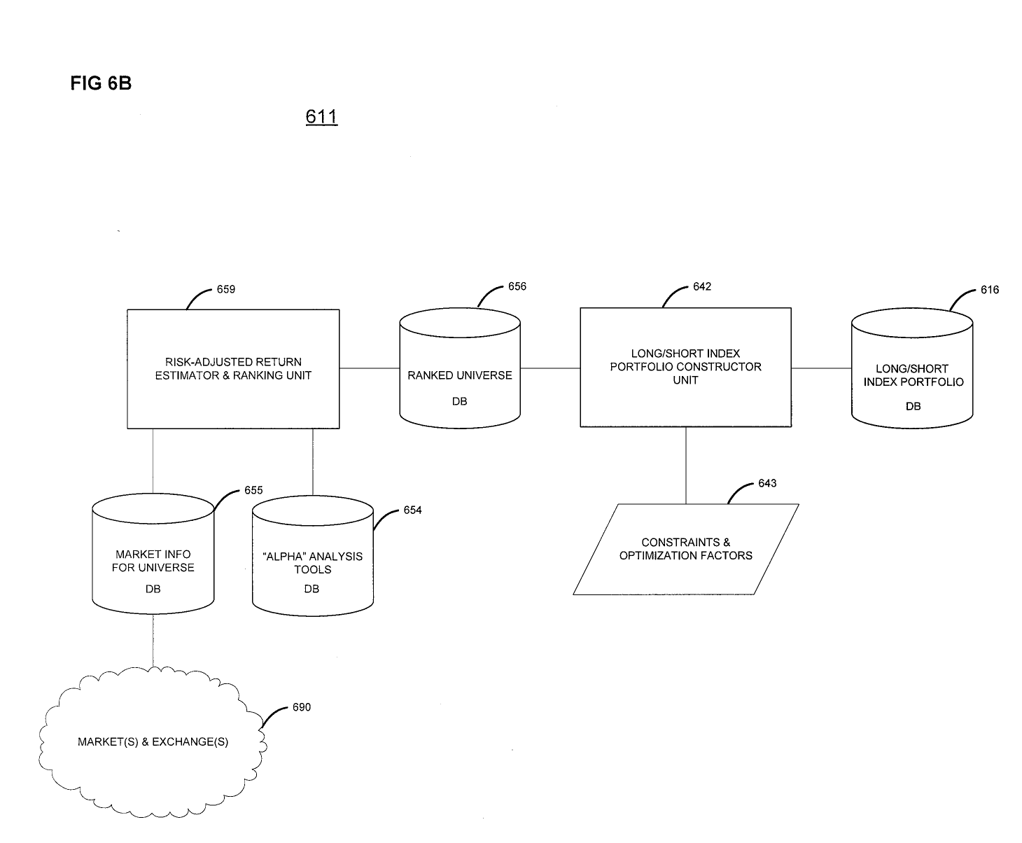

FIG. 6A illustrates a system 610 for generating, maintaining, and publishing a benchmark according to an embodiment of the invention. The system 610 may comprise various computer processing units and databases residing on one or more computer. The long/short index portfolio database 615 may contain information regarding which stocks and how many shares of the stocks are included in a benchmark portfolio. The value of the stocks in the benchmark portfolio may be calculated on an intra-day or an end-of-day basis in an intra-day/end-of-day long/short portfolio index valuation unit 620. The intra-day valuation may be conducted periodically, monthly, hourly, every 30 minutes, 1 minute, or 15 seconds or less, as determined by the benchmark creator. It may, in the alternatively, be performed dynamically or continuously. The results may be published, for example, on the Internet, by a long/short portfolio index publishing unit 630 periodically, monthly, hourly, every 30 minutes, 1 minute, 15 seconds or less, or dynamically.

A long/short portfolio updater and adjuster unit 640 may update market and corporate event information concerning stocks contained in the benchmark portfolio and make adjustments to the stocks contained in the benchmark portfolio based on such updated information. The result of any adjustments is used to update the long/short index portfolio database 615. The long/short portfolio updater and adjuster unit 640 may determine what, if any, updates need to be made to the benchmark portfolio based on inputs from a variety of database, including a ranked universe database 651, a market info database 652, and a corporate events database 653 as depicted in 610. The contents of these databases may be gathered from a variety of sources, including market information, exchange information, news and media sources, etc. 690 as depicted in FIG. 6A. This information gathering may be performed dynamically by a computer application unit that survey information available over the Internet or by manual inputs of financial analysts, or both.

FIG. 6B depicts various computer processing units and databases residing on one or more computer for generating and maintaining a benchmark. The system 611 may include a long/short index portfolio database 616 that contains information regarding the stocks and the numbers of shares of the stocks included in a benchmark portfolio. The stocks and the number of shares of the stocks included in the benchmark portfolio may be updated periodically, dynamically, or manually.

The system 611 may also include a risk-adjusted return estimator ranking unit 659 that retrieves information from a market info database 655 and an “alpha” analysis tools database 654. The market info database 655 may include various information regarding the expected performance of each stocks in an eligible universe of stocks that may be included in the benchmark portfolio. The information in the market info database 655 may be collected from a variety of sources, including market information and exchange information, news, and other media sources 690 as depicted in FIG. 6B. Further, some of the information may concern extraordinary corporate events or other events that may significantly affect the value of a stock. Some information may indicate that certain adjustments may be made to the eligible universe of stocks improve the benchmark portfolio. The market info database 655 may be used to store such information.

The alpha analysis tools database 654 may include information regarding alpha forecasting factors that may be used to predict which stocks in the eligible universe are likely to perform well in the future. For example, the alpha analysis tools database 654 may combine the 10 Credit Suisse factor or other alpha forecasting factors for each stocks to assess the expected return of each stock.

The risk-adjusted return estimator and ranking unit 659 may combine inputs from the market info database 655 and the alpha analysis tools database 654 to rank the universe of eligible stocks that may be included in the benchmark portfolio. For example, the risk-adjusted return estimator and ranking unit 659 may retrieve the list of all companies included in the S&P 500 Index or other broad-base index that is stored in a market info database 655 and combine excess return inputs calculated from the Credit Suisse alpha factors or other alpha forecasting factors that are stored in a “alpha” analysis tools database 654 to rank a set of eligible stocks. The ranking may then be stored in the ranked universe database 656.

The ranking stored in the ranked universe database 656 may be retrieved by a long/short index portfolio constructor unit 642 that determines which stocks and how many shares of the stocks should be included in the benchmark portfolio. The long/short index portfolio constructor unit 642 may be configured to take in information regarding constraints and optimization factors 643, either manually or automatically. The constraints may include constraints on the percentage of stocks that may be replaced from the current benchmark portfolio on a rebalancing date. For example, for a 130/30 index portfolio, a constraint may be set so that no more than 30% based on value of the stocks in a current benchmark portfolio may be changed with non-constituent shares of stocks on each rebalancing date. Using the input from the ranked universe database 656 and the constrains and optimization factors set by the index creator, the long/short index portfolio constructor unit 642 may determine the contents of the rebalanced benchmark portfolio, and store the same in the long/short index portfolio database 616. As depicted in FIG. 6A, the information stored in the long/short index portfolio 616 of FIG. 6B may then be further processed in an intra-day/end-of-day long/short portfolio index valuation unit 620 and be published by a long/short portfolio index publishing unit 630.

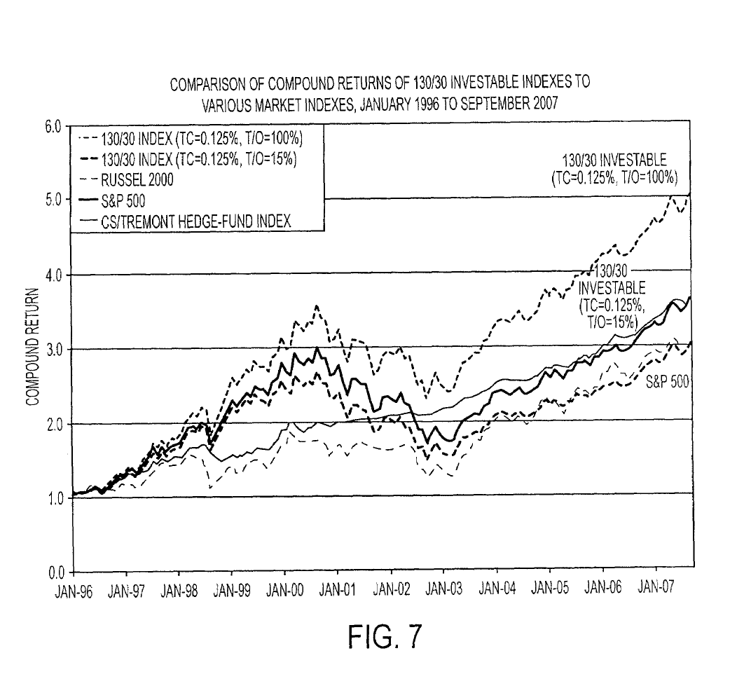

FIG. 7 is a graph that depicts the cumulative returns of a 130/30 Investable Index. This data was obtained by setting up a 130/30 Investable Index according to one embodiment and running a historical simulation using real financial data from the past. The selection and rebalancing of the securities in the index portfolio was performed on a MSCI Barra Aegis Portfolio Manager provided with the Barra U.S. Equity Long-Term Risk Model. A 130/30 investable portfolio and a look-ahead portfolio was set up and rebalanced on a monthly basis from January 1996 to September 2007 by initially starting with $100,000,000 in cash. For each month, the S&P 500 Index was used as the benchmark and the universe in the portfolio construction. The following specifications were used in configuring the MSCI Barra Aegis Portfolio Manager to select the shares for the 130/30 index portfolio:

Constraints. Constrain the portfolio beta to equal one.

Expected Returns. For each company in the S&P 500 and for each date, use the equal-weighted average of its corresponding ten composite-alpha-factor z-scores as the excess-return input into the optimizer when constructing the investable portfolio, and use the one-month forward excess return when constructing the look-ahead portfolio. Set the risk-free rate, the benchmark risk premium, and the expected benchmark surprise all to zero.

Optimization Type. Use long/short portfolio optimization. Set the long and the short position leverage to 130% and 30%, respectively.

Trading. Do not put any constraints on the holding and trading threshold levels, and set the active weight to 40 basis points. This yields a tracking error, defined as the annualized standard deviation of the difference between the portfolio and the benchmark daily return series, between 1.5% and 3% for each month.

Risk. Use the Barra default setting, which includes the following specifications: mean return of zero, probability level of 5%, risk aversion value of 0.0075, and AS-CF risk aversion ratio of 1.

Transaction Costs. Set the one-way transaction costs to 0.125% and construct portfolios with three different levels of annualized turnover—15%, 100%, and unconstrained—which is intended to span the relevant range of interest for most investors and managers.

Tax Costs. Do not assume any model for the tax costs.

See Appendix I for the step-by-step procedures used on the MSCI Barra Optimizer to construct the 130/30 investable portfolio.

According to the parameters and settings described in Appendix I, the portfolio optimization process generates the optimal number of shares to be held for each stock in the 130/30 portfolio for each month. Now, for each stock i in the portfolio, the following monthly information is obtained: the number of shares Sᵢₜ₋₁ at the end of the previous month, the price per share Pᵢₜ₋₁ at the end of the previous month, and total return for the month Rᵢₜ. Use this information to form the net-of-cost monthly 130/30 portfolio total return Rₚₜ as follows:

$$\begin{matrix}{R}_{pt} ≡ {\sum }_{i} \frac{{P}_{it - 1} {S}_{it - 1}}{{\sum }_{j} {P}_{jt - 1} {S}_{jt - 1}} {R}_{it} - {TCost}_{t} - {SCost}_{t} & ( 1 a ) \\ {TCost}_{t} ≡ 0.0025 \times 2 \times 1.6 \times {Turnover}_{t} & ( 1 b ) \\ {SCost}_{t} ≡ 0.3 \times 0.0075 / 12 & ( 1 c )\end{matrix}$$

where TCostₜ is the direct transaction cost incurred in month t, Turnoverₜ is the monthly turnover as calculated by the MSCI Barra Aegis Portfolio Manager, and SCostₜ is the cost associated with the short side of the 130/30 portfolio (i.e., the spread between the short rebate and the borrowing cost due to the use of leverage).

A “look-ahead” index may be created at month-end using the same portfolio construction process as for the investable index, but replacing the expected excess-return forecast with the realized excess return for that month. Rather than creating a z-score as the proxy for the expected excess return, simply the difference between the one-month forward return and the current month's return is used as the expected excess-return input into the MSCI Barra Aegis Portfolio Manager. A portfolio created in this manner obviously has “perfect foresight” since it uses realized returns in place of expected-return forecasts, and returns for this portfolio will serve as an upper limit to the total available alpha. Because this portfolio is created with the same constraints as the investable index, the return for the portfolio will be the maximum potential return available for the 130/30 strategy. Investors and portfolio managers may use this return to gauge the amount of alpha captured by their own portfolios, which may be a useful measure of alpha decay over time.

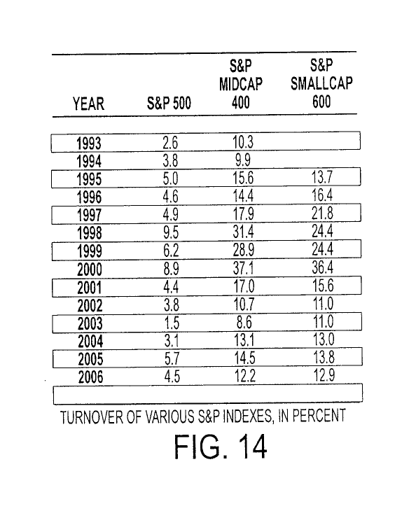

Using the above described procedures with data from January 1996 to September 2007, the returns of this 130/30 strategy was constructed assuming a one-way transaction cost of 0.125% for three different levels of annual turnover: 15%, 100%, and unconstrained. The selected universe of securities was the S&P 500. Therefore, a one-way transaction cost of 0.125% was considered to be an over-estimate for the most liquid names, but was considered empirically more plausible for the smaller-cap stocks in that universe. And since the S&P 500 has an annual turnover of 2% to 10%, as shown in FIG. 14, a turnover level of 15% preserves the passive nature of the 130/30 portfolio while allowing it to respond each month to changes in the underlying alpha factors. Therefore, most analysis centered on this case.

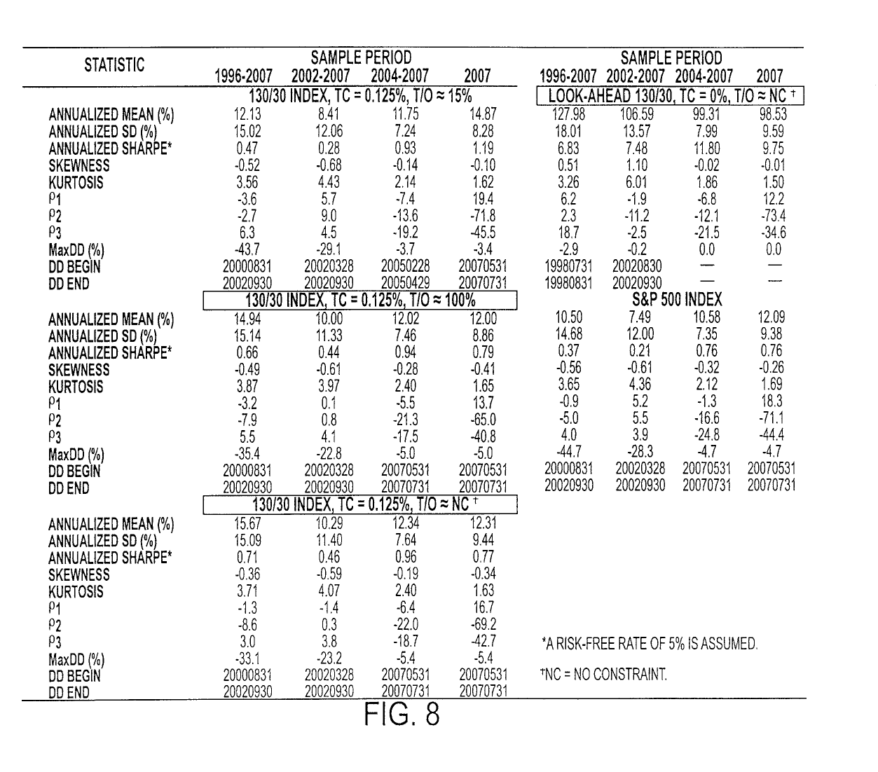

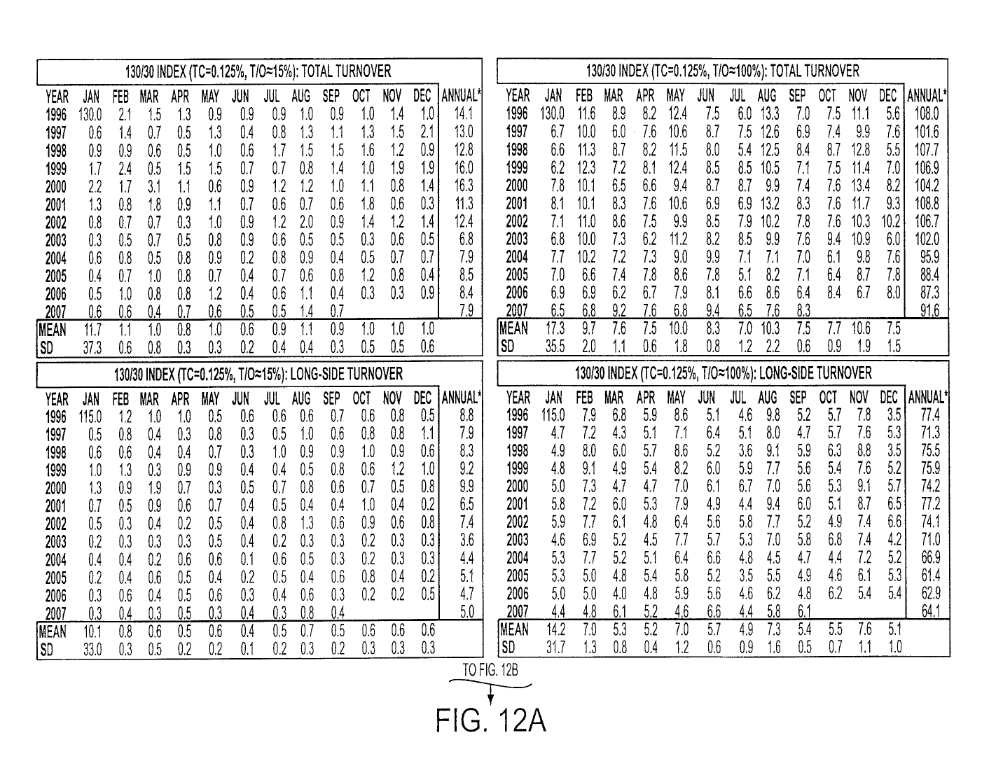

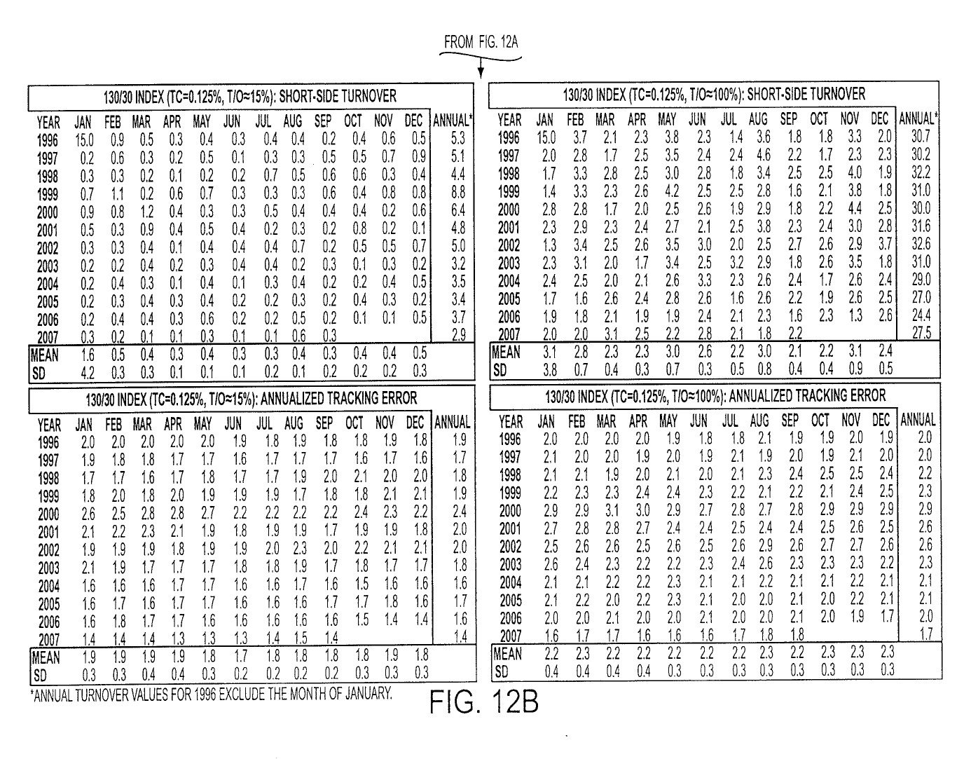

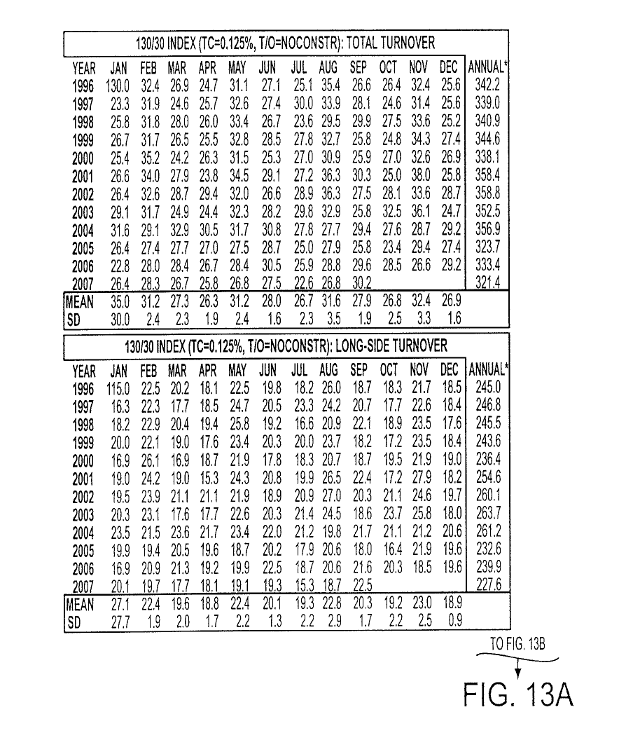

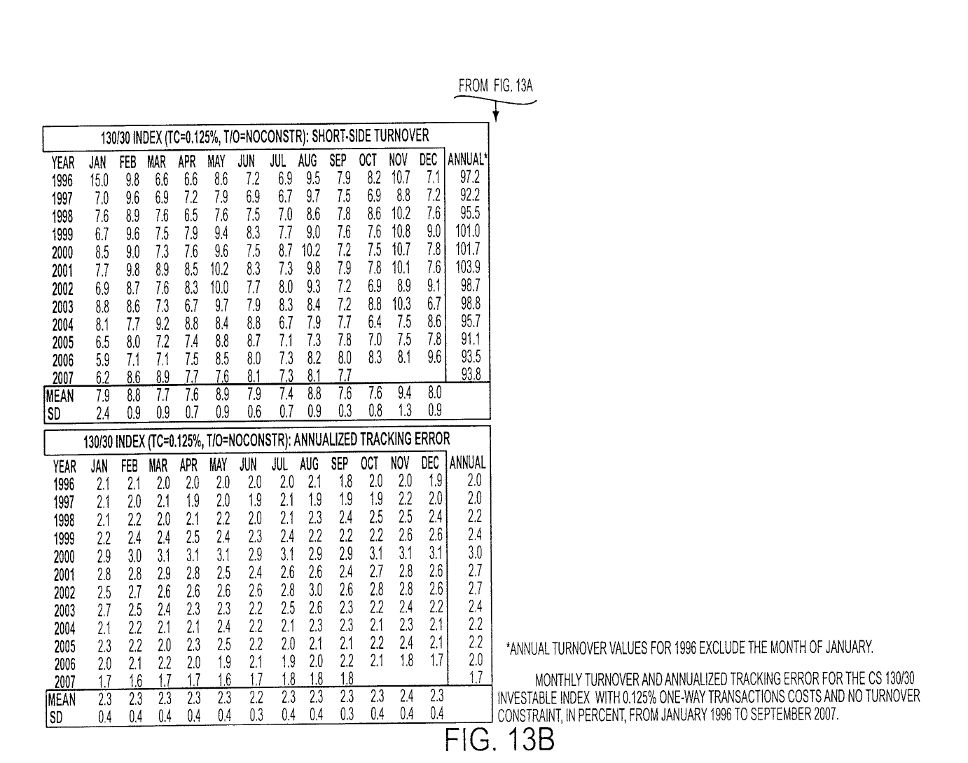

The table shown in FIG. 8 summarizes the performance of the 130/30 index for 0.125% one-way transaction costs and three different levels of annualized turnover constraints—15%, 100%, and unconstrained—and also includes the performance of the look-ahead portfolio produced by the above described process and a securities universe defined by the S&P 500 index. The average return of the 130/30 index is 15.67% with no turnover constraints, and declines to 14.94% and 12.13% with turnover constraints of 100% and 15%, respectively. The difference in performance between the unconstrained and constrained portfolios is not surprising, given the differences in the amount of trading required for their implementation—the unconstrained portfolio generates approximately 350% turnover per year, as compared to a turnover of 100% and 15% for the constrained cases. Please refer to the tables shown in FIGS. 12 and 13.

Transaction costs have little impact on the volatility of the 130/30 index, which is approximately 15% for the investable index under all three levels of turnover and is similar to the 14.68% standard deviation of the S&P 500. This volatility level implies a Sharpe ratio of 0.47 for the 130/30 index with 0.125% one-way costs and a 15% annualized turnover constraint, assuming a 5% risk-free rate, which compares favorably with the S&P 500 index's Sharpe ratio of 0.37. Of course, some have argued that such a comparison is inappropriate because the 130/30 strategy is leveraged, and this argument is the very motivation for our index.

FIG. 7 plots the cumulative returns of the 130/30 Investable Index (with 0.125% one-way transaction costs and 15% and 100% annualized turnover constraints) and other popular indexes such as the S&P 500, the Russell 2000, and the CS/Tremont Hedge-Fund Index. These plots show that the 130/30 index behaves more like traditional equity indexes than the CS/Tremont Hedge-Fund Index, but does exhibit some performance gains over the S&P 500 and Russell 2000.

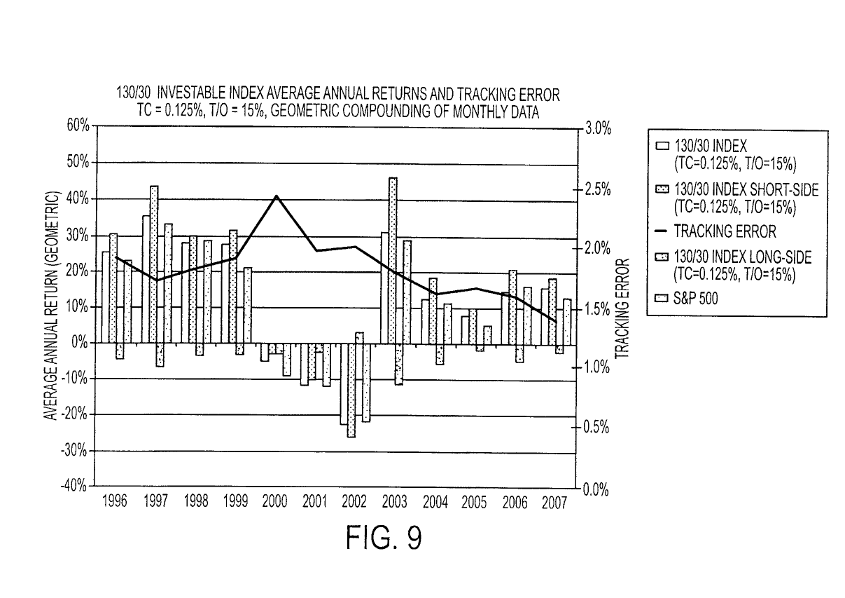

These performance gains are more readily captured by FIG. 9, in which the geometrically compounded annual returns of the 130/30 strategy with 0.125% one-way costs and a 15% annualized turnover constraint are plotted, as well as the strategy's long-side and short-side returns and the comparable S&P 500 returns, where the long-side (short-side) returns are defined as the returns of the strategy's long (short) positions. With the exception of 2002, FIG. 9 shows that the short positions of the 130/30 portfolio hurt performance, hence it is tempting to conclude that the short side adds little value. However, this interpretation ignores the diversification benefits that the short positions yield, as well as the flexibility to take more active risk on the long side while maintaining a unit beta and a 100% dollar exposure for the portfolio.

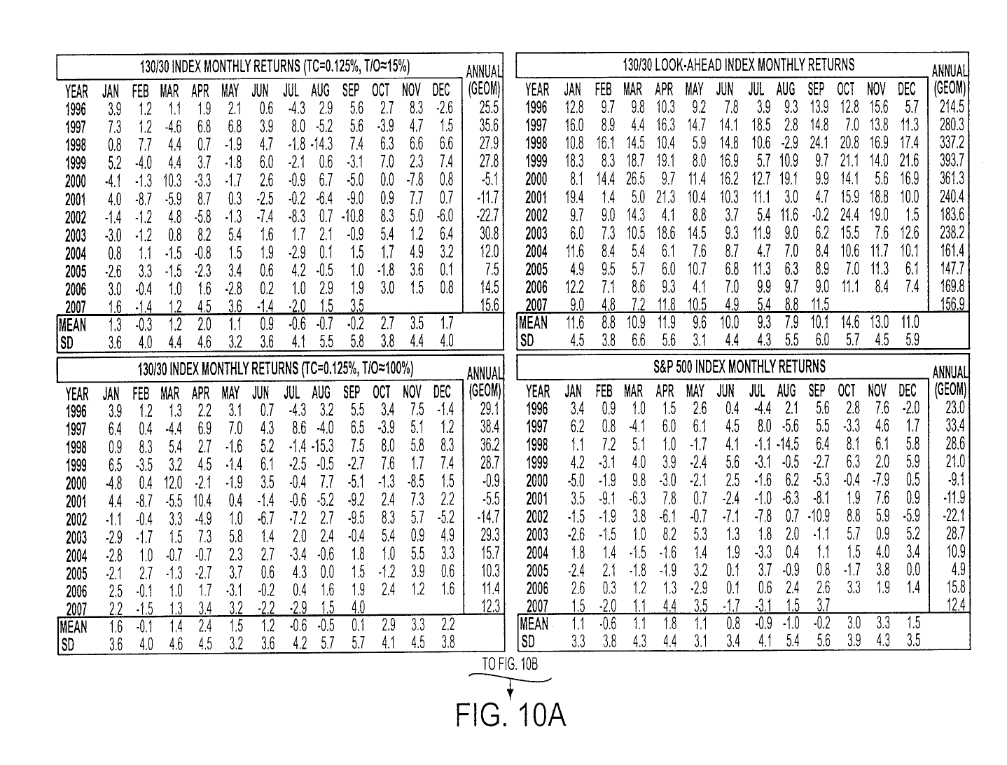

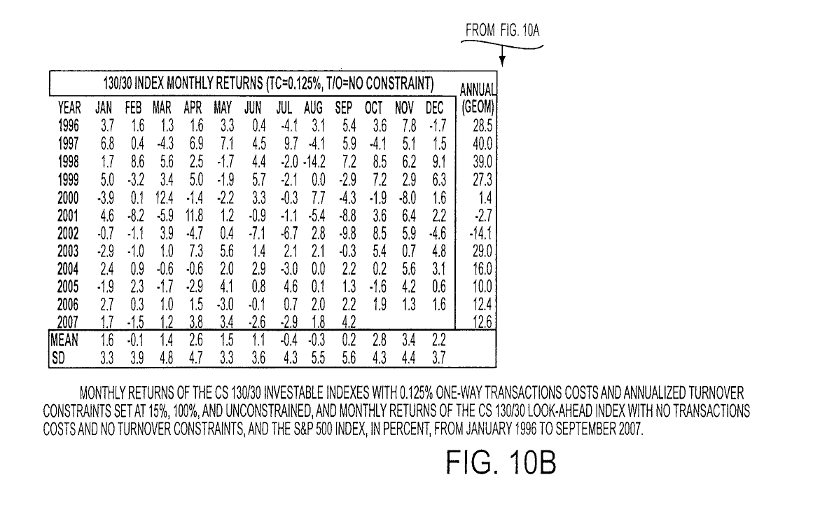

A year-by-year comparison of the 130/30 strategy with the S&P 500 suggests that the increased flexibility of the 130/30 portfolio does seem to yield benefits over and above the S&P 500. However, there are periods such as 1998, 2002, and 2006 where the 130/30 strategy can underperform its long-only counterpart. The table shown in FIG. 10 contains the monthly and annual returns of the various 130/30 investable and look-ahead indexes and the S&P 500 index, and a direct comparison shows that the annualized tracking error of the 130/30 index with 0.125% one-way costs and a 15% annualized turnover constraint is 1.85% and the average excess return associated with this 130/30 index 1.63%, implying an information ratio (IR) of 0.88. However, given the passive and transparent nature of the 130/30 strategy, this impressive IR cannot be interpreted as a sign of “alpha”, but rather as the benefits of increased flexibility provided by the 130/30 format.

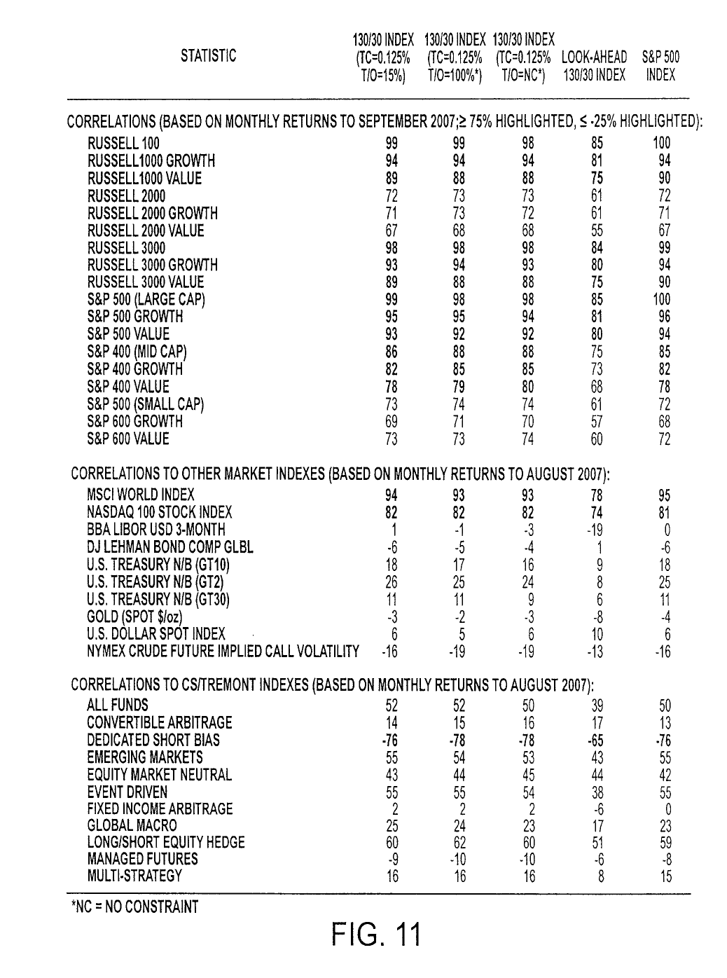

Apart from these performance differences, the table shown in FIG. 8 illustrates that the remaining statistical properties of 130/30 index returns are virtually indistinguishable from those of the S&P 500. In the table shown in FIG. 11, the correlations of the 130/30 index with 0.125% one-way costs and 15%, 100%, and unconstrained annual turnover to various market indexes, key financial assets, and hedge-fund indexes are illustrated. Not surprisingly, the 130/30 index is highly correlated with all of the equity indexes, and the correlation coefficients are nearly identical to those of the S&P 500. The second two sub-panels of the table shown in FIG. 11 show the same patterns—the 130/30 index and the S&P 500 have almost identical correlations to stock, bond, currency, commodity, and hedge-fund indexes.

To develop a sense for the implementation issues surrounding the 130/30 index, FIGS. 12 and 13 report the monthly and annual turnover and yearly averages of the annualized tracking errors (obtained from the MSCI Barra Aegis Portfolio Manager each month) of the 130/30 portfolio with 0.125% one-way transaction costs where the annualized turnover was constrained to either 15% or 100%, or left unconstrained. The turnover of the 130/30 index ranges from a high of 16.3% in 2000 to a low of 6.8% in 2003, and is typically 1% per month. For comparison, the table shown in FIG. 14 contains the turnover of several S&P indexes. In contrast to the 130/30 index which is intended to be a dynamic basket of securities, the S&P indexes are static, changing only occasionally as certain stocks are included or excluded due to changes in their characteristics. Therefore, as a buy-and-hold index, the turnover of the S&P 500 is typically much lower than that of the 130/30 index, but the table of FIG. 14 shows that even for the S&P 500, there are years when this static portfolio exhibits turnover levels approaching the levels of the 130/30 index, e.g., 1998 when the turnover in the S&P 500 index is 9.5%. Moreover, for other static S&P indexes such as the Mid Cap 400, the turnover levels exceed those of the 130/30 index, hence the practical challenges of implementing the 130/30 index are no greater than those posed by many other popular buy-and-hold indexes.

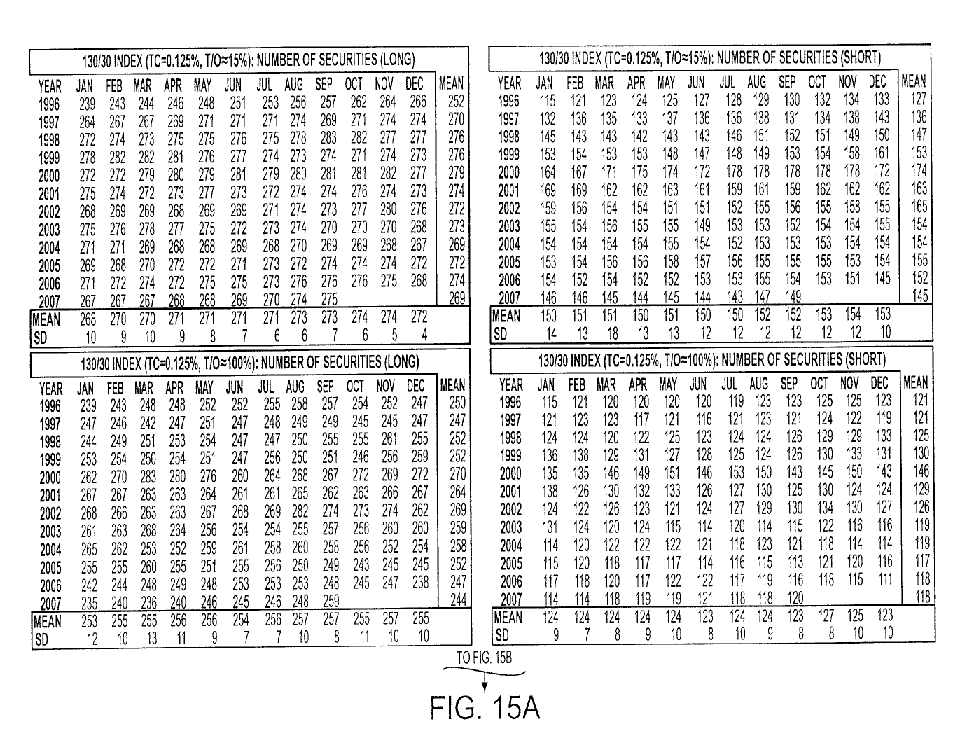

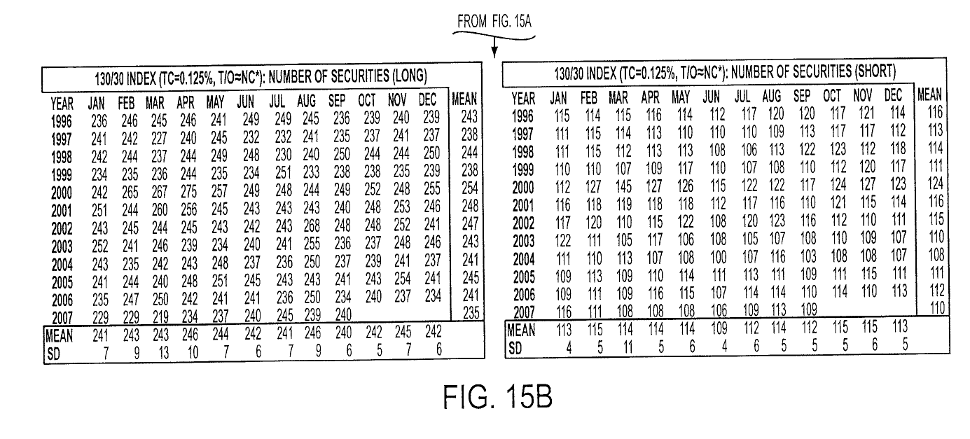

The table shown in FIG. 15 contains the number of securities held on the long and short sides of the 130/30 index with 0.125% one-way costs and with turnover constraints set at 15%, 100%, and unconstrained. On average, the 130/30 index with 15% turnover is long 270 names and short 150 names, yielding a fairly well-diversified portfolio. In this respect, the 130/30 portfolio resembles a typical U.S. large-cap core enhanced-index strategy where the active weights are more variable over time and across stocks, thanks to the loosening of the long-only constraint.

While various embodiments of the present invention have been described above, it should be understood that they have been presented by way of example only, and not as limitation. It will be apparent to those skilled in the art that various changes in form and detail can be made therein without departing from the spirit and scope of the invention, and such embodiments are within the purview of the present invention. Thus, the scope of the present invention should not be limited by any of the above-described embodiments, but should be defined only in accordance with the following claims and their equivalents. All patents and publications discussed herein are incorporated by reference.

### APPENDIX I

The following is the step-by-step procedures used on the MSCI Barra Optimizer to construct the 130/30 investable portfolio. (The specific MSCI Barra keywords are typeset in boldface.)

Open the Barra Aegis System Portfolio Manager.

On the drop-down menu, select Data→Select Model and Dates. Select the file containing the data for a particular date for which optimization is to be run, and hit OK.

On the drop-down menu, select Data→Benchmarks, Markets, and Composites, and hit the button Remove All. Now hit the button Add File, and go to the Barra data folder corresponding to your date of interest to add the appropriate index (SAP500.por). Press Process and then OK.

On the drop-down menu, select Data→Import User Data. First press Clear All. Then go to the file containing the composite-alpha-factor z-scores for the S&P 500 companies on the date of interest. Highlight the file and select Add. Press Process and then OK. For the purposes of further directions, assume that the z-scores variable in the user input file is labeled as “Value”.

Build the portfolio. On the drop-down menu, select File→Portfolio. Make sure the date is correct and hit OK. On the drop-down menu, select Portfolio→Settings. Within the Settings window, select the following:

General Tab

1. For the Benchmark field, hit Select and choose the index you just added (SAP500).

2. Set the Market field to Cash by pressing the Cash button.

3. If you are not doing this process for the first time in a series, set the Initial Portfolio field to the previous month's optimized portfolio by pressing the Browse button. Otherwise set the Initial Portfolio field to a portfolio containing $100 million in cash and no other assets.

4. To populate the Universe field, hit the button Use benchmark as universe.

5. Base Value option should be set to Net Value, which is the default.

Tax Costs Tab

Everything in this tab should be disabled by default.

Optimize Tab

1. Under the Optimization Type heading, set the Portfolio option to Long-Short.

2. Under the Cash heading, leave the Cash Contribution at 0.00.

3. Under the Transactions heading, select Allow All.

4. Under the Leverage heading, enter the following parameters:
(a) Max. Long Position 130.00
(b) Min. Long Position 130.00
(c) Min. Short Position=30.00
(d) Max. Short Position=30.00

Risk Tab

Under the Return Distribution Parameters heading, set:

1. Mean Return=Zero

2. Show Function Type=Probability Density

3. Number of Bins=24

4. Probability Level (%)=5

5. Leave the box Truncate Total Return at—100% unchecked.

Under the Risk Aversion heading, set:

1. Value=0.0075

2. AS-CF Risk Aversion Ratio=1.0000

Constraints Tab

1. Constraint Priority=Default

2. Constraint Type=Beta

3. Constraints on=Net

4. Set the Factor field to Beta and the corresponding Min and Max fields both to 1, and leave the Soft box unchecked.

Expected Returns Tab

Under the Expected Asset Returns heading, select the following:

1. For the Return Source field, select User Data→“Value”.

2. Leave the Description and Formula fields blank.

3. Set the Return Type to Excess for these directions since z-scores are used.

4. Set the Return Multiplier to 0.0100 (in general, this will depend on the scale of the input z-scores), and do not define anything for the Expected Factor Return.

Under the Return Refinement Parameters heading, select the following:

1. Risk Free=0.00%

2. Benchmark Risk Premium=0.00%

3. Expected Benchmark Surprise=0.00%

4. Market Risk Premium=0.00%

5. Expected Market Surprise=0.00%

Transaction Costs Tab

1. Barra Market Impact Model=Off

2. Analysis Mode=One Way, and Holding Period (years)=1.00

3. Overall Transaction Costs (Buy Costs, Sell Costs, and Short Sell Costs) should all be set to the desired transaction cost level (0.00% for the unconstrained-turnover optimization and 0.125% for the constrained-turnover optimization) Plus 0.0000 Per Share.

4. Asset Specific Transaction Costs (Buy Costs, Sell Costs, and Short Sell Costs) should all be set to <none> Plus <none> Per Share.

5. Transaction Cost Multiplier is set to 1.0000 for the unconstrained-turnover optimization, and to 1.3500 or 12.0000 for the constrained-turnover simulations. One-way transaction costs of 0.125% and a transaction cost multiplier of 1.35 yields turnover of approximately 100% per year, and when the transaction cost multiplier is increased to 12, the annualized turnover drops to 15%.

Penalties Tab

Leave the default setting (blank).

Formulas Tab

Leave the default setting (blank).

Advanced Constraints Tab

Leave it disabled (default).

Trading Tab

All of the General Constraints boxes should be left unchecked, except for the Allow Crossovers box, which should be checked. All of the Turnover boxes and all of the Trade Limits boxes should be left unchecked.

Holdings Tab

Under the Asset Level Bounds, set:

1. Upper Bound %=<none>

2. Lower Bound %=<none>

Under the Grandfather Rule heading, leave everything unchecked.

Under the General Holding Bounds heading, set:

1. Upper Bound %=b+0.40

2. Lower Bound %=b −0.40

Under the Conditional Rule heading, the Apply Conditional Rule box should be left unchecked.

At the bottom-right of the Settings window press the Apply button, then at the top-right of the same window press OK.

From the drop-down menu, select Actions→Optimize.

Save the resulting output.

What is claimed is:

1. A method for maintaining a benchmark using a long/short investment strategy, the method comprising:
periodically evaluating securities in a benchmark portfolio;
periodically rebalancing the benchmark portfolio based on a long/short investment strategy; and
calculating value of the benchmark portfolio.

2. A method of claim 1, wherein the benchmark is a passive benchmark.

3. A method of claim 2, further comprising periodically publishing the value of the benchmark portfolio as a benchmark.

4. A method of claim 1, wherein one or more securities to include in the benchmark portfolio are chosen from securities included in the S&P 500 Index, the S&P 1500 Index, other broad-base index, or combination of one or more thereof.

5. A method of claim 1, wherein the periodic evaluating of the securities involves using expected return estimating factors involving each of the securities' traditional value; relative value; historical growth; expected growth; profit trend; accelerating sales; earnings momentum; price momentum; price reversal; and small size.

6. A method of claim 1, wherein the periodic evaluating of the securities involves using 10 Credit Suisse factors.

7. A method of claim 1, wherein the calculating of the value of the benchmark portfolio is based on closing prices of securities in the benchmark portfolio.

8. A method of claim 1, further comprising calculating a look-ahead index based on realized returns of securities in the benchmark portfolio.

9. A method for generating a passive long/short benchmark, comprising:
obtaining alpha forecast factors of each securities found in a set of eligible securities;
inputting the alpha forecast factors to a long/short investment strategy optimizer to determine which and how much of securities from the set to include in a benchmark portfolio; and
generating the benchmark portfolio with the securities identified by the optimizer.

10. The method of claim 9, wherein the set of eligible securities include all securities included in the S&P 500 Index, the S&P 1500 Index, or a broad-base index.

11. A method for generating and managing a passive long/short investment portfolio that correlates with a benchmark, comprising:
creating a portfolio of securities based on a benchmark that uses a long/short investment strategy;
monthly evaluating each security in a collection of eligible securities;
monthly rebalancing the portfolio to correlate with the benchmark; and
offering a portion of the portfolio to an investor,
wherein the monthly evaluating involves using expected return estimating factors involving each of the securities' traditional value; relative value; historical growth; expected growth; profit trend; accelerating sales; earnings momentum; price momentum; price reversal; and small size.

12. The method of claim 11, wherein the creating of the portfolio involves selecting securities from securities included in the benchmark that uses a long/short investment strategy.

13. The method of claim 12, wherein the monthly evaluating involves using 10 Credit Suisse factors.

14. The method of claim 11, wherein performance of the portfolio correlates with a passive 130/30 benchmark within 90%.

15. The method of claim 11, wherein performance of the portfolio correlates with a passive 130/30 benchmark within 95%.

16. The method of claim 11, wherein performance of the portfolio correlates with a passive 130/30 benchmark within 98%.

17. A method of using a long/short benchmark to rebalance a portfolio, comprising:
comparing performance of a portfolio to a long/short benchmark; and
rebalancing the portfolio using the benchmark, the benchmark being generated and maintained by:
monthly evaluating securities in a benchmark portfolio;
monthly rebalancing the benchmark portfolio using a long/short investment strategy;
determining value of securities in the rebalanced benchmark portfolio; and
publishing the value as a benchmark.

18. The method of claim 17, wherein securities to include in the benchmark portfolio is chosen from securities included in one or more of broad-base index or securities traded at one or more stock exchanges.

19. A system, comprising:
a data storage;
an expected return forecasting unit that predicts performance of one or more securities in a benchmark portfolio; and
a long/short investment strategy rebalancing unit configured to rebalance the benchmark portfolio using an input from the expected return forecasting unit,
wherein the rebalancing unit is configured to rebalance the benchmark portfolio monthly.

20. The system of claim 19, further comprising a database configured to store information regarding securities included in the benchmark portfolio.

21. A computer-readable medium storing instructions executable by a processor, the instructions comprising:
creating a portfolio of securities using a long/short investment strategy;
monthly evaluating the securities of the portfolio; and
monthly rebalancing the portfolio using a long/short investment strategy,
wherein the evaluating involves using expected return estimating factors involving each of the securities' traditional value; relative value; historical growth; expected growth; profit trend; accelerating sales; earnings momentum; price momentum; price reversal; and small size.

22. A passive long/short financial product, comprising:
a portfolio of securities,
wherein contents of the portfolio are selected by a computer application based on alpha forecast factors, and the contents are periodically rebalanced on the computer application based on a passive long/short benchmark that uses alpha forecasting factors to rank securities in a benchmark portfolio.

23. A financial product, comprising:
a portfolio of securities,
wherein contents of the portfolio is selected based on a query run on a computer application that generates or obtains a passive long/short strategy benchmark.

24. A computer device configured to:
generate a benchmark based on a long/short strategy; and
transform the benchmark into a portfolio of securities.

25. A passive and investable long/short strategy index, the index comprising a benchmark portfolio that is managed by:
creating the benchmark portfolio using a long/short investment strategy;
monthly evaluating securities in the benchmark portfolio; and
monthly rebalancing the benchmark portfolio using a long/short investment strategy,
wherein the monthly evaluating involves using expected return estimating factors involving each of the securities' traditional value; relative value; historical growth; expected growth; profit trend; accelerating sales; earnings momentum; price momentum; price reversal; and small size.
